(19) United States
(12) Patent Application Publication
(10) Pub. No.: US 2026/0264057 A1
(43) Pub. Date: Sep. 10, 2026

(54) METHANE OXIDATION CATALYSTS, METHODS OF USING THEREOF, AND METHODS OF MAKING THEREOF

(71) Applicant: YALE UNIVERSITY, New Haven, CT (US)

(72) Inventors: Jake HEINLEIN, New Haven, CT (US); Shu HU, New Haven, CT (US); Dean TAKAHASHI, New Haven, CT (US)

(21) Appl. No.: 19/472,097

(22) PCT Filed: Apr. 4, 2024
(86) PCT No.: PCT/US2024/022932

§ 371 Date: Oct. 3, 2025

Related U.S. Application Data
(60) Provisional application No. 63/494,121, filed on Apr. 4, 2023.

(51) Int. Cl. B01J 23/44; B01J 21/06; B01J 23/22; B01J 23/34; B01J 23/50; B01J 27/04; B01J 27/14; B01J 35/39; B01J 37/02

(52) U.S. Cl. CPC B01J 23/44; B01J 21/063; B01J 23/22; B01J 23/34; B01J 23/50; B01J 27/04; B01J 27/14; B01J 35/39; B01J 37/0228; B01J 37/0244

(57) ABSTRACT

Catalysts for selective oxidation of methane and methods of making and using thereof have been developed. The catalysts can be incorporated into reactors which allow for the capture and oxidation of methane from gas streams, such as by photochemical means.

### CROSS-REFERENCE TO RELATED APPLICATIONS

This application claims the benefit of and priority to U.S. Application No. 63/494,121 filed Apr. 4, 2023, the contents of which are incorporated by reference herein in their entirety.

### FIELD OF THE INVENTION

This invention is in the field of catalysts, especially selective catalysts for oxidation of gaseous methane and aqueous biomass materials.

### BACKGROUND OF THE INVENTION

Various greenhouse gases are being emitted into the air and contribute to rising global temperatures by trapping heat in the atmosphere. Mitigating and removing CO₂ emissions from the atmosphere has received the most attention so far. However, methane is a more powerful greenhouse gas, which is able to trap up to 80 times more heat than CO₂. While methane concentrations in the atmosphere are still very low, atmospheric methane concentrations continue rising every year due to human activity.

Although methods of capturing dilute CO₂ from the atmosphere or from the ocean are known, technology does not yet exist that can remove dilute methane from air. There is also a need for methods of oxidizing other greenhouse generating materials, such as aqueous biomass materials.

Accordingly, there is a challenge to prevent continued global warming and climate change by capturing and converting methane from the atmosphere and/or other methane producing sources (i.e., mine vents, landfills, livestock, cow farms, permafrost, etc.) into more benign products, which produce less global warming or can be captured.

Therefore, there is a need for materials and methods for capturing and converting methane from the atmosphere and/or other methane producing sources, as well as from sources, such as from aqueous biomass materials.

There also is a need for methods for making and using such materials capable of capturing and converting methane from the atmosphere and/or other methane producing sources.

Therefore, it is an object of the invention to provide catalytic materials capable of capturing and converting gaseous methane into other products.

It is also an object of the invention to provide methods of making such catalytic materials.

It is also an object of the invention to provide to provide methods of using such catalytic materials capturing and converting gaseous methane into other products.

It is still a further object of the invention to provide to provide reactor systems containing such catalytic materials.

### SUMMARY OF THE INVENTION

Catalysts and structures containing thereof which are selective for oxidation of methane into carbon dioxide are described herein. In some instances, a non-limiting catalytic structure includes:
an optional base substrate;
a light absorbing layer coating on the optional base substrate, if present;
an optional protective coating layer on the light absorbing layer;
a catalyst coating the protective coating layer, if present, wherein the catalyst coating includes:
   (1) at least a first component comprising a first metal oxide and an optional metal, wherein the first metal oxide is alloyed or doped with at least one metal selected from the group consisting of silver, iron, palladium, rhodium, iridium, nickel, titanium, chromium, platinum, and combinations thereof; and
   (2) optionally at least a second component comprising at least a second metal oxide selected from the group consisting of manganese, chromium, vanadium, cobalt, iron, nickel, iridium, ruthenium, and combinations thereof.

In some other instances, a non-limiting catalytic structure can include:
an optional base substrate;
a light absorbing layer coating on the optional base substrate, if present;
an optional protective coating layer on the light absorbing layer;
a catalyst coating the protective coating layer, if present, wherein the catalyst coating includes one or more metal co-catalysts, wherein the metal of each co-catalyst is selected from the group consisting of silver, iron, palladium, rhodium, iridium, nickel, titanium, chromium, platinum, and combinations thereof. In such instances, the one or more metal co-catalysts may be formed of two metals, such as transition metals, where one metal forms a core and second metal forms a shell over the core. In some other instances, the catalyst coating is formed directly on the light absorbing layer and can be formed of a single metal catalyst, which can be made of a metal selected from the group consisting of silver, iron, palladium, rhodium, iridium, nickel, titanium, chromium, and platinum.

In one instance, a non-limiting method of preparing the catalytic structures, as described herein, can include the steps of:
(a) depositing or forming a light absorbing layer on a base substrate;
(b) optionally depositing or forming a protective coating layer onto the light absorbing layer;
(c) depositing or forming a catalyst coating onto the protective coating layer, wherein the catalyst coating is formed by the steps of:
(d) depositing at least a first component by atomic layer deposition and/or by sputtering at a predetermined deposition temperature, wherein the at least first component comprises a first metal oxide and an optional metal, wherein the first metal oxide is alloyed or doped with at least one metal selected from the group consisting of silver, iron, palladium, rhodium, iridium, nickel, titanium, chromium, platinum, and combinations thereof; and
(e) optionally depositing at least a second component by atomic layer deposition and/or by sputtering at a predetermined temperature on the at least first component; wherein the second component comprises at least a second metal oxide selected from the group consisting of manganese, chromium, vanadium, cobalt, iron, nickel, iridium, ruthenium, and combinations thereof;
   wherein steps (d) and (e) are optionally repeated one or more times.

In another instance, a non-limiting method of preparing the catalytic structures, as described above, can include the steps of:
(a′) depositing or forming a light absorbing layer on a base substrate;
(b′) depositing or forming a protective coating layer onto the light absorbing layer; and
(c′) depositing or forming a catalyst coating onto the protective coating layer, wherein the catalyst coating is formed by the steps of sequentially depositing one or more metal co-catalysts, where each metal is independently selected from transition metals, by depositing a first metal, which can act a site which facilitates the deposition of a second metal, and depositing a second metal.

The catalytic structures described herein can form part of a device. In some instances, methane is oxidized into carbon dioxide by use of the catalytic structures described herein, when the structures are used in a device, such as a flow reactor, and a gas stream containing methane is flowed over the catalytic structures in the reactor.

In some instances, a device, such as a reactor, can include at least one catalytic structure. In some instances, the device includes a plurality of catalytic structures (i.e., at least 2, 3, 4, 5, 6, 7, 8, 9, 10, 11, 12, 13, 14, 15, or more catalytic structures). Such devices can be used in the methods described below.

In one non-limiting instance, a method of oxidizing methane to form carbon dioxide therefrom, includes the steps of:
(i) contacting one or more catalytic structures, as described herein, with methane; and
(ii) applying an effective amount of a stimulus sufficient to drive oxidation of the methane to form carbon dioxide.

The catalytic structures and/or devices thereof can be provided as a kit. The kits can contain the catalytic structures along with instructions for use thereof, and the end user incorporates the catalytic structure(s) into a device(s), as discussed above.

### BRIEF DESCRIPTION OF THE DRAWINGS

FIG. 1A shows a non-limiting representation of a catalytic panel 100 including a base substrate 110, a light absorbing layer 120 coating the base substrate, a protective layer 130 coating the light absorbing layer, and a catalyst coating layer 140 on the protective coating layer. The catalyst coating layer being formed of co-catalysts, optionally as islands or nanoclusters, formed of a core 145 and at least one shell 150.

FIG. 1B shows a non-limiting representation of a catalytic panel 100′ including a base substrate 110′, a light absorbing layer 120′ coating the base substrate, and a catalyst coating layer 140′ on the light absorbing layer. The catalyst coating layer being formed of a single metal catalyst, optionally as islands or nanoclusters.

FIG. 2 shows a non-limiting representation of a large-scale methane reactor 200 having at least three catalytic panels 100 therein where a gas stream containing methane flows over the catalytic panels, as depicted by the gas flow arrow shown.

FIG. 3 shows a non-limiting representation of a lab-scale methane reactor 300 having one catalytic panel 100 therein where a gas stream containing methane flows over the catalytic panel, as depicted by the gas flow arrow shown.

FIG. 4A is a graph of methane conversion (%) as a function of time (mins) from exemplary Pd—Ag—(Ti,Mn)_{4:1}Oₓ—CdS panels. FIG. 4B is a graph of CO₂ partial pressure (torr) as a function of time (mins) from exemplary Pd—Ag—(Ti,Mn)_{4:1}Oₓ—CdS panels.

FIG. 5A is a graph of methane conversion (%) as a function of time (mins) from exemplary Pd—Ag—(Ti,Mn)_{4:1}Oₓ—GaP panels. FIG. 5B is a graph of CO₂ partial pressure (torr) as a function of time (mins) from exemplary Pd—Ag—(Ti,Mn)_{4:1}Oₓ—GaP panels.

FIGS. 6A and 6B show GC results for Pd-BVO panels under catalytic reaction in in the presence of ethanol (6A) and in the presence of 30 wt % hydrogen peroxide (6A). The grey backgrounds represent when the blue LEDs were on. In FIG. 6B, there are two sets of dotted lines, where the top line is for methane and the bottom line is for oxygen. Each GC run cycle took approximately 13 minutes. The time did not start at 0 to allow for time for the GC and gas flow to equilibrate.

FIG. 7 shows GC results for Pd—Ag-BVO panels for the methane and oxygen levels for the Pd—Ag-BVO panels. The panels were first dipped in hydrogen peroxide and later the argon flow was switched to bubble through a solution of ethanol, both instances are marked with dotted lines, where the top line is for methane and the bottom line is for oxygen. The grey backgrounds represent when the blue LEDs were turned on.

### DETAILED DESCRIPTION OF THE INVENTION

Methane oxidation and biomass oxidation catalysts and methods of making and using thereof are described herein.

### I. Definitions

“Photocatalyst”, as used herein, refers to a catalyst capable of accelerating photochemical reactions in the presence of the catalyst and under light energy input.

“Oxidatively stable” as used herein, means that more than 90%, more than 92%, more than 94%, more than 95%, more than 98%, more than 99%, more than 99.5%, more than 99.9%, more than 99.95%, more than 99.99% of the catalyst remain active or operational in the presence of one or more reactants and applied potentials, over a broad pH range (e.g., 1-12) for at least 7 days, 14 days, 21, days, 28 days, 30 days, 45 days, two months, three months, four months, five months, six months, one year, or longer at ambient temperature and ambient light conditions. Alternatively, the catalyst undergoes less than 10%, less than 5%, less than 1%, less than 0.5%, less than 0.1%, less than 0.05%, or less than 0.01% degradation under the conditions described above.

“Hydrolytically stable”, as used herein, means that more than 90%, more than 92%, more than 94%, more than 95%, more than 98%, more than 99%, more than 99.5%, more than 99.9%, more than 99.95%, more than 99.99% of the catalyst is intact in the presence of water over a broad pH range (e.g., 3-9) for at least 7 days, 14 days, 21, days, 28 days, 30 days, 45 days, two months, three months, four months, five months, six months, one year, or longer at ambient temperature and ambient light conditions. Alternatively, the catalyst undergoes less than 10%, less than 5%, less than 1%, less than 0.5%, less than 0.1%, less than 0.05%, or less than 0.01% hydrolysis under the conditions described above.

“Thermally stable”, as used herein, means that more than 90%, more than 92%, more than 94%, more than 95%, more than 98%, more than 99%, more than 99.5%, more than 99.9%, more than 99.95%, more than 99.99% of the catalyst is structurally intact at room temperature or lower or when heated to a temperature above room temperature.

“Turn-over number” or “TON”, as used herein, means the number of moles of substrate that a mole of catalyst converts in the timeframe of the experiment or before being deactivated.

“Turn-over frequency” or “TOF”, as used herein, refers to the turnover per unit time under turnover conditions. It is typically expressed in s⁻¹. The TOF can be calculated by dividing the TON by the time period, in seconds, over which the TON was measured.

“Turn-over conditions”, as used herein, refers to the conditions in which a catalytic reaction takes place.

Numerical ranges disclosed in the present application include, but are not limited to, ranges of temperatures, ranges of times, ranges of current densities, ranges of pH, ranges of overpotentials, ranges of Faradaic efficiencies, ranges of integers, and ranges of thicknesses, amongst others. The disclosed ranges, disclose individually each possible number that such a range could reasonably encompass, as well as any sub-ranges and combinations of sub-ranges encompassed therein. For example, disclosure of a time range is intended to disclose individually every possible time value that such a range could encompass, consistent with the disclosure herein.

Use of the term “about” is intended to describe values either above or below the stated value, which the term “about” modifies, in a range of approx. +/−10%; in other instances the values may range in value either above or below the stated value in a range of approx. +/−5%. When the term “about” is used before a range of numbers (i.e., about 1-5) or before a series of numbers (i.e., about 1, 2, 3, 4, etc.) it is intended to modify both ends of the range of numbers and/or each of the numbers recited in the entire series, unless specified otherwise.

### II. Catalytic Structures for Methane and Biomass Oxidation

Catalysts and structures containing thereof which are selective for oxidation of methane into carbon dioxide and oxidation of biomass into hydrogen and biochar are described herein.

In some instances, a non-limiting catalytic structure includes:
an optional base substrate;
a light absorbing layer coating on the optional base substrate, if present;
an optional protective coating layer on the light absorbing layer;
a catalyst coating the protective coating layer, if present, wherein the catalyst coating includes:
   (1) at least a first component comprising a first metal oxide and an optional metal, wherein the first metal oxide is alloyed or doped with at least one metal selected from the group consisting of silver, iron, palladium, rhodium, iridium, nickel, titanium, chromium, platinum, and combinations thereof; and
   (2) optionally at least a second component comprising at least a second metal oxide selected from the group consisting of manganese, chromium, vanadium, cobalt, iron, nickel, iridium, ruthenium, and combinations thereof.

In some other instances, a non-limiting catalytic structure can include:
an optional base substrate;
a light absorbing layer coating on the optional base substrate, if present;
an optional protective coating layer on the light absorbing layer;
a catalyst coating the protective coating layer, if present, wherein the catalyst coating includes one or more metal co-catalysts, wherein the metal of each co-catalyst is selected from the group consisting of silver, iron, palladium, rhodium, iridium, nickel, titanium, chromium, platinum, and combinations thereof. In such instances, the one or more metal co-catalysts may be formed of two metals, such as transition metals, where one metal forms a core and second metal forms a shell over the core. In some other instances, the catalyst coating is formed directly on the light absorbing layer and can be formed of a single metal catalyst, which can be made of a metal selected from the group consisting of silver, iron, palladium, rhodium, iridium, nickel, titanium, chromium, and platinum.

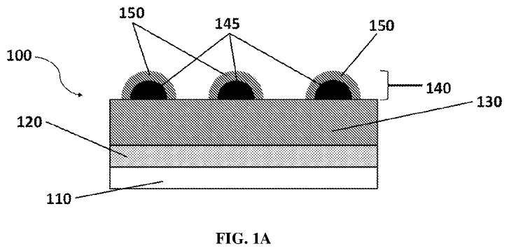

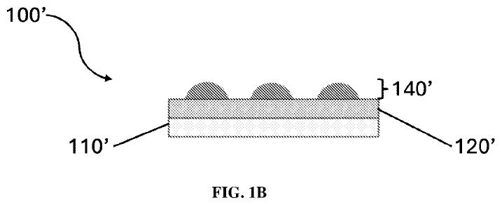

Details of the optional base substrate, light absorbing layer, protective coating layer, and catalyst coating are provided below. A non-limiting example of a catalytic structure is shown in FIG. 1A where the exemplary structure is a catalytic panel 100 including an optional base substrate 110, a light absorbing layer 120 coating the base substrate, a protective layer 130 coating the light absorbing layer, and a catalyst coating layer 140. The catalyst coating layer being formed of co-catalysts, optionally as islands or nanoclusters, formed of a core 145 and at least one shell 150. Another non-limiting example is shown in FIG. 1B where the exemplary structure is a catalytic panel 100′ including an optional base substrate 110′, a light absorbing layer 120′ coating the base substrate, and a catalyst coating layer 140′. The catalyst coating layer being formed of a single catalyst, optionally as islands or nanoclusters.

### A. Optional Base Substrate

The catalytic structures are typically formed on a base substrate. The base substrate may be selected from any suitable material that offers transparency to all or at least a portion of the visible spectrum, preferably including at least light having blue wavelengths. In some instances, the base substrate is made of glass or plastic. In some instances, the base substrate is frosted and can be made of a frosted glass.

The base substrate is not particularly limited in shape, dimension, or thickness. Any suitable shape (i.e., square, rectangular, regular or irregular shape), dimension (such as width, length), and thickness may be used as suitable for providing a catalytic structure, such as a panel for use in a reactor. In certain instances, the base substrate is a planar base substrate. Suitable base substrate may be obtained from commercial sources having the desired shape, dimension, or thickness. The skilled person would also be able to modify aspects of a base substrate, such as shape/dimension, using known techniques for purposes of making a catalytic structure.

### B. Light Absorbing Layer

A light absorbing layer can be formed over at least one planar surface of an optional base substrate, when present. In some instances, all or substantially all of the at least one planar surface is coated with light absorbing layer. “Substantially all” refers to at least 85%, 90%, 95%, 96%, 97%, 98%, 99%, 99.5%, or 99.9% of the surface area of the base substrate is coated by the light absorbing layer.

In some instances, the light absorbing layer is made of or includes CdSe, CdS, BiVO₄, CdSₓSe₁₋ₓ where x is greater than 0 and/or less than 1, GaAs, GaP, AlAs, InAs, GaAsₓP₁₋ₓ where x is greater than and/or less than 1, AlₓGa₁₋ₓAs where x is greater than 0 and/or less than 1, AlₓGa₁₋ₓAs_{y}P_{1-y} where x is greater than 0 and/or less than 1 and y is greater than 0 and/or less than 1, InₓGa₁₋ₓAs where x is greater than 0 and/or less than 1, InₓGa₁₋ₓP where x is greater than 0 and/or less than 1, InxGa₁₋ₓAs_{y}P_{1-y} where x is greater than 0 and/or less than 1 and y is greater than 0 and/or less than 1, AlₓIn₁₋ₓAs_{y}P_{1-y} where x is greater than 0 and/or less than 1 and y is greater than 0 and/or less than 1, AlₓGa₁₋ₓAs_{y}N_{z}P_{1-y-z} where x is greater than 0 and/or less than 1 and y is greater than 0 and/or less than 1, and z is greater than 0 and/or less than 1-y, InₓGa₁₋ₓAs_{y}N_{z}P_{1-y-z} where x is greater than 0 and/or less than 1 and y is greater than 0 and/or less than 1, and z is greater than 0 and/or less than 1-y, Zn₃P₂, Zn₃S₂, and ZnPₓS₁₋ₓ where x is greater than 0 and/or less than 2 and combinations thereof.

In some other instances, the light absorbing layer is made of or includes a metallic material selected from the group consisting of Ti, Al, TiN, Ir, Pd, Pt, Ni, Ru, Ta, conductive oxides of Ir, Pd, Pt, Ni, Sn, Zn, indium or Al-doped SnO₂, Al or Ga doped ZnO, metal silicides, metal germanides, metal nitrides and combinations thereof.

In some instances, the light absorbing layer is made of or comprises bismuth vanadium oxide (BVO; BiVO₄).

In some instances, the light absorbing layer has a thickness in a range from between about 3 nm to about 10 micrometers, as well as any sub-ranges or individual values contained within.

### C. Optional Protective Coating Layer

An optional protective coating layer is formed over the light absorbing layer, such as the exposed top surface of the layer. In some instances, such as when the light absorbing layer is bismuth vanadium oxide (BiVO₄ or BVO) there is typically no protective layer present. However, in some instances, a device having a BVO light absorbing layer can include a protective coating layer over the BVO layer. In some instances, all or substantially all of the light absorbing layer's surface is coated with a protective coating layer, which forms a layer coating on the light absorbing layer. “Substantially all” refers to at least 85%, 90%, 95%, 96%, 97%, 98%, 99%, 99.5%, or 99.9% of the surface area of the surface of the light absorbing layer.

In some instances, the protective coating layer is formed of:
(1′) at least a first layer comprising at least a first metal oxide alloyed or doped with at least one metal selected from the group consisting of manganese, chromium, vanadium, cobalt, oxides thereof, and combinations thereof; and
(2′) at least a second layer comprising at least a second metal oxide which is optionally free or substantially free of the least one metal selected from the group consisting of manganese, chromium, vanadium, cobalt, nickel, oxides thereof, and combinations thereof.

Although reference is made above to first and second layers, in some instances, these layers may be indistinct and may form an intermixed single layer. The intermixed single layer would include the at least a first metal oxide alloyed or doped with at least one metal selected from the group consisting of manganese, chromium, vanadium, cobalt, oxides thereof, and combinations thereof of the first layer and the at least a second metal oxide which is optionally free or substantially free of the least one metal selected from the group consisting of manganese, chromium, vanadium, cobalt, oxides thereof, and combinations thereof of the first and second layers, respectively. The intermixed single layer may be a layer impermeable to water moisture and dissolved ions (wherein “impermeable” refers to less than 5 wt. %, 4 wt. %, 3 wt. %, 2 wt. %, 1 wt. %, or 0 wt. % transfer of water (moisture) and/or dissolved ions).

In some instances, the at least first and/or the second layers of the protective coating are formed by atomic layer deposition (ALD) and/or by sputtering at a predetermined deposition temperature. Exemplary methods of making the layered catalyst are provided below.

In some instances, the at least first and/or the second layers of the protective coating layer are annealed. Annealing is usually carried out in air or under an inert atmosphere (such as nitrogen, argon, helium, or a mixture thereof) at a temperature ranging from between about 300 to 700° C., 300 to 600° C., or 300 to 500° C. for a period of time ranging from between about 0.1 to 8 hours, 0.1 to 5 hours, or 0.1 to 3 hours, as well as sub-ranges or individual values disclosed within. In some instances, the annealing temperature is about 300° C., 350° C., 400° C., 450° C., 500° C., 550° C., or 600° C. In some instances, the annealing time is about 0.1, 0.5, 1, 1.5, 2, 2.5, 3, 3.5, 4, 4.5, 5, 5.5, 6, 6.5, 7, 7.5, or 8 hours. In some cases, the annealing may be carried out with controlled heating ramp rates and/or controlled cooling ramp rates, or heating and/or cooling may be uncontrolled. Suitable heating or cooling ramp rates include about 1° C./min, 2° C./min, 3° C./min, 4° C./min, or 5° C./min, or higher.

In some instances, the at least first and/or second metal oxide is formed of a metal oxide selected from a titanium dioxide, a tin oxide, a tungsten oxide, or a combination thereof. In some cases, the metal oxides of the at least first layer can include titanium dioxide (titanium(IV) oxide), titanium(II) oxide, titanium(III) oxide, tin(II) oxide, tin(IV) oxide, tungsten(III) oxide, tungsten(IV) oxide, tungsten(VI) oxide, tungsten pentoxide, or combinations thereof. In the case of the at least first layer these metal oxides are alloyed or doped with the at least one metal selected from the group consisting of manganese, chromium, vanadium, cobalt, nickel oxides thereof, and combinations thereof. In certain instances, the at least second layer is free or substantially free of the least one metal selected from the group consisting of manganese, chromium, vanadium, cobalt and nickel. “Substantially free,” as used here in refers to an atomic percentage present in the layer of a metal which less than 5%, 4%, 3%, 2%, 1%, 0.9%, 0.8%, 0.7%, 0.6%, 0.5%, 0.4%, 0.3%, 0.2%, 0.1%, or less.

In some instances, the layered catalyst can be free or substantially free of iridium, ruthenium, or platinum. “Substantially free,” as used here in refers to an atomic percentage present in the layer of a metal which less than 5%, 4%, 3%, 2%, 1%, 0.9%, 0.8%, 0.7%, 0.6%, 0.5%, 0.4%, 0.3%, 0.2%, 0.1%, or less.

The atomic percentage of the at least one metal doped (such as less than 5%) or alloyed (such as above 3% to 99.9%) in the at least first metal oxide can be in the range of between about 1 and 80%, 1 and 75%, 1 and 70%, 1 and 60%, 1 and 50%, 10 and 50%, 20 and 50%, 30 and 50% of the at least first layer, either alone or in combination with the at least second layer, as well as sub-ranges or individual values disclosed within. In some other instances the atomic percentage of the at least one metal doped or alloyed in the at least first metal oxide is at least about 1%, 5%, 10%, 15%, 20%, 25%, 30%, 35%, 40%, 45%, 50%, 55%, 60%, 70%, 75%, or 80% of the at least first layer, either alone or in combination with the second layer. In yet some other instances the atomic percentage of the at least one metal doped or alloyed in the at least first metal oxide is up to about 1%, 5%, 10%, 15%, 20%, 25%, 30%, 35%, 40%, 45%, 50%, 55%, 60%, 70%, 75%, or 80% of the first layer, either alone or in combination with the second layer. The atomic percentages in a given layer may be determined by techniques such as X-ray photoelectron spectroscopy (XPS). The atomic percentages can be controlled by the parameters selected for the ALD or sputtering process, for example the pulse cycles, amongst other selected parameters discussed below. The ALD or sputtering process can also be used to control the spatial distribution of the least one metal doped or alloyed into the at least first metal oxide. For example, the spatial distribution across a cross-section or the thickness of the first layer may be uniform, non-uniform, or form a gradient. In one non-limiting example, when a gradient is formed the atomic percentage of the at least one metal doped or alloyed into the at least first metal oxide is highest (most concentrated) at the top surface of the layer/film and decreases in concentration through the film thickness toward the bottom surface, or vice versa.

In some instances, the metal oxide of the first layer is alloyed or doped with a metal selected from the group consisting of manganese, chromium, vanadium, cobalt, nickel, and can be defined according to Formula (1) or Formula (2):

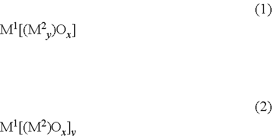

where M¹ is selected from the group consisting of manganese, chromium, vanadium, cobalt, and combinations thereof; M² is selected from the group consisting of titanium, tin, tungsten, and combinations thereof; and y is a composition value which is a >0 real number, such as a value from 0-3, 0-2, 1-3, or 1-2, and x is a composition value which is a >0 real number, such as a value from 0-3, 0-2, 1-2, or 1-3. In some cases, x and y are each integer values of the specified ranges. In some instances, (M²)Oₓ of Formula (2) is a stoichiometric oxide.

The thicknesses of the at least first layer and/or the at least second layer may independently be selected/controlled to be in the range of about 1-100 nm, 5-100 nm, 5-90 nm, 5-80 nm, 5-70 nm, 5-60 nm, 5-70 nm, 5-60 nm, 5-50 nm, 5-40 nm, 5-30 nm, 5-25 nm, 5-20 nm, or 5-10 nm, as well as sub-ranges or individual values disclosed within. In some instances, the combined thickness of the at least first layer and/or the at least second layer is selected/controlled to be in the range of about 1-100 nm, 5-100 nm, 5-90 nm, 5-80 nm, 5-70 nm, 5-60 nm, 5-70 nm, 5-60 nm, 5-50 nm, 5-40 nm, 5-30 nm, 5-25 nm, 5-20 nm, or 5-10 nm, as well as sub-ranges or individual values disclosed within. It understood that the combined thickness defines the thickness of the layered catalyst coating described.

In some instances, the at least first and the at least second layers together may be described as a nanolaminate which is a composite layer or film formed from different materials in a layered stack, where the layers may be alternating layers having a thickness on the order of nanometers. A nanolaminate is not limited to alternating layers of each material, but may include having several layers of one material alternating with a single layer of the other material, to obtain a desired ratio of the two or more materials. A nanolaminate may also include layers of one material formed by an ALD reaction either over or under a single layer of a different material formed by another type of reaction, such as a sputtering reaction. The layers of different materials may remain separate after deposition and/or annealing, or they may be modified, such as by annealing.

It is believed that the protective coating layer is conductive to the hot energy carriers (electrons and holes) generated from the semiconductor (i.e., CdS, GaP, or other suitable materials named herein) making up the light absorbing layer when these are excited by blue light photons.

In some other instances, the protective coating layer can be formed of, or can include, one or more components selected from a group consisting of TiO₂, SrTiO₃, SnO₂, K₂Ti₂O₅, K₂Ti₄O₉, BaTiO₃, PbTiO₃, ZrO₂, HfO₂, SnO₂, In₂O₃, FeOₓ, MnOₓ, NiOₓ, CoOₓ, WO₃, ZnO, Ta₂O₅, NbOₓ, Al₂O₃, MgO, SiO₂, and BiOₓ where x is greater than or equal to 1 and/or less than or equal to 2.5.

In some instances, the protective coating layer is formed of a metal oxide selected from the group consisting of a titanium dioxide, a tin oxide, a tungsten oxide, and combinations thereof.

In some instances, the protective coating layer has a thickness in a range from between about 1 nm to about 200 nm, as well as any sub-ranges or individual values contained within.

In some less preferred instances, one can substitute the protective coating layer, as described above, for a metal oxide coating layer. In some instances, the metal oxide coating is formed of a single layer of titanium(IV) oxide, titanium(II) oxide, or titanium(III) oxide. Methods of forming such metal oxide coatings, such as by ALD, are known to the person of ordinary skill in the art. The thicknesses of such a metal oxide coating layer can be selected/controlled to be in a range of about 1-100 nm, 5-100 nm, 5-90 nm, 5-80 nm, 5-70 nm, 5-60 nm, 5-70 nm, 5-60 nm, 5-50 nm, 5-40 nm, 5-30 nm, 5-25 nm, 5-20 nm, or 5-10 nm, as well as sub-ranges or individual values disclosed within.

### D. Catalyst Coating Layer

In some instances, the catalyst coating layer can include:
(1) at least a first component comprising a first metal oxide and an optional metal, wherein the first metal oxide is alloyed or doped with at least one metal selected from the group consisting of silver, iron, palladium, nickel, titanium, chromium, platinum, and combinations thereof; and
(2) optionally at least a second component comprising at least a second metal oxide selected from the group consisting of manganese, chromium, vanadium, cobalt, iron, nickel, iridium, ruthenium, and combinations thereof.

In some instances, the catalyst coating can be optionally in the form of a layer. In some instances, which can be considered an alternative to the catalyst coating layer described immediately above, the catalyst coating layer can be formed of one or more co-catalysts, such as metal co-catalysts. Typically, two metals are used to form such metal co-catalysts. The metals can be selected from transition metals. In some instances, the metals of the catalyst are silver and palladium. In some instances, deposition of co-catalysts involves selecting and depositing a first transition metal which can act a site which facilitates the deposition of a second transition metal. In such instances, the one or more co-catalysts can form a core-shell motif, where a first metal forms a core and a second metal forms a shell over the core. An example of such a motif is shown in FIG. 1. The size and dimensions of such core-shell metal co-catalysts is not particularly limited.

In some instances, the catalyst coating or components thereof can have a total thickness which can range from between about 0 nm to about 100 nm, or about 10 nm to 20 nm, or about 10 nm to 90 nm, or about 20 nm to 80 nm, or about 30 nm to 70 nm, or about 40 nm to 60 nm, as well as sub-ranges or individual values disclosed within.

In some instances, the optional metal of the first component includes a core-shell structure or a core-shell-shell structure, where the core is a metal, a metal oxide or combinations therein, and each shell, as may be present, is a metal, a metal oxide, or a metal oxide alloy of a metal, where the metal can be selected from silver, iron, palladium, rhodium, iridium, nickel, titanium, chromium, platinum, and combinations thereof; oxides thereof, or metal oxide alloys thereof. In still other instances, the core of a core-shell structure can be made of silver and the shell of the core-shell structure can be Ag—CrOₓ, where x is greater than 0 and less than 1.5, or a titanium oxide, such as TiOₓ, where x is greater than 0 and less than 2. In yet other instances, the core of the core-shell-shell structure is made of silver, the first shell of the core-shell-shell structure is palladium, and the second shell of the core-shell-shell structure is a chromium oxide, such as CrOₓ, where x is greater than 0 and less than 1.5, or a titanium oxide, such as TiOₓ, where x is greater than 0 and less than 2.

In some instances, the catalyst coating is formed of co-catalysts which form (nano)islands or (nano)clusters on a surface, such as the top exposed surface, of the protective coating layer. As shown in FIG. 1A, the catalyst coating layer may include islands or clusters having a first transition metal and second transition metal coating the first transition metal. As shown in FIG. 1B, the catalyst coating layer may include islands or clusters having a single transition metal, such as palladium, on the light absorbing layer. In some instances, the at least first and/or the second components form islands and/or clusters; optionally wherein the islands can be nano-islands and/or the clusters can be nano-clusters. “Islands,” as used herein refer to a disc shape having a thickness of about 1 nm to 50 nm and a diameter ranging from about 2 nm to 500 nm, as well as sub-ranges or individual values disclosed within. “Cluster,” as used herein refers to a spherical shape having a diameter of about 1 nm to 500 nm, as well as sub-ranges or individual values disclosed within.

In still other instances, the at least first component can further include an oxide surface layer containing a metal selected from the group consisting of silver, palladium, nickel, or combinations thereof.

Preferably, the catalyst coating layer is not annealed.

### III. Methods of Preparing Catalytic Structures for Methane and Biomass Oxidation

In one instance, a non-limiting method of preparing the catalytic structures, as described above, can include the steps of:
(a) depositing or forming a light absorbing layer on a base substrate;
(b) optionally depositing or forming a protective coating layer onto the light absorbing layer;
(c) depositing or forming a catalyst coating onto the protective coating layer, wherein the catalyst coating is formed by the steps of:
(d) depositing at least a first component by atomic layer deposition and/or by sputtering at a predetermined deposition temperature, wherein the at least first component comprises a first metal oxide and an optional metal, wherein the first metal oxide is alloyed or doped with at least one metal selected from the group consisting of silver, iron, palladium, rhodium, iridium, nickel, titanium, chromium, platinum, and combinations thereof; and
(e) optionally depositing at least a second component by atomic layer deposition and/or by sputtering at a predetermined temperature on the at least first component; wherein the second component comprises at least a second metal oxide selected from the group consisting of manganese, chromium, vanadium, cobalt, iron, nickel, iridium, ruthenium, and combinations thereof;
   wherein steps (d) and (e) are optionally repeated one or more times.

In another instance, a non-limiting method of preparing the catalytic structures, as described above, can include the steps of:
(a′) depositing or forming a light absorbing layer on a base substrate;
(b′) depositing or forming a protective coating layer onto the light absorbing layer; and
(c′) depositing or forming a catalyst coating onto the protective coating layer, wherein the catalyst coating is formed by the steps of sequentially depositing one or more metal co-catalysts, where each metal is independently selected from transition metals, by depositing a first metal, which can act a site which facilitates the deposition of a second metal, and depositing a second metal.

### A. Base Substrate

As noted above, the base substrate may be selected from any suitable material that offers transparency to all or at least a portion of the visible spectrum, preferably including at least light having blue wavelengths. In some instances, the base substrate is made of glass or plastic. In some instances, the base substrate is frosted and can be made of a frosted glass.

The base substrate is not particularly limited in shape, dimension, or thickness. Any suitable shape (i.e., square, rectangular, regular or irregular shape), dimension (such as width, length), and thickness may be used as suitable for providing a catalytic structure, such as a panel for use in a reactor. In certain instances, the base substrate is a planar base substrate. Suitable base substrate may be obtained from commercial sources having the desired shape, dimension, or thickness. The skilled person would also be able to modify aspects of a base substrate, such as shape/dimension, using known techniques for purposes of making a catalytic structure.

In some instances of the methods, the base substrate, prior to (a) is cleaned. The base substrate may be cleaned with one or more solvents, such as water, acetone, aqueous acids (i.e., HCl solution).

### B. Light Absorbing Layer

A light absorbing layer is typically formed on a base substrate but may alternatively be formed or deposited as a standalone layer. In other words, the method may exclude a base substrate where the light absorbing layer is formed or deposited as a standalone layer during step (a) above.

In some instances, the light absorbing layer is made of or includes CdSe, CdS, BiVO₄, CdSₓSe₁₋ₓ where x is greater than 0 and/or less than 1, GaAs, GaP, AlAs, InAs, GaAsₓP₁₋ₓ where x is greater than and/or less than 1, AlₓGa₁₋ₓAs where x is greater than 0 and/or less than 1, AlₓGa₁₋ₓAs_{y}P_{1-y} where x is greater than 0 and/or less than 1 and y is greater than 0 and/or less than 1, InₓGa₁₋ₓAs where x is greater than 0 and/or less than 1, InₓGa₁₋ₓP where x is greater than 0 and/or less than 1, InₓGa₁₋ₓAs_{y}P_{1-y} where x is greater than 0 and/or less than 1 and y is greater than 0 and/or less than 1, AlₓIn₁₋ₓAs_{y}P_{1-y} where x is greater than 0 and/or less than 1 and y is greater than 0 and/or less than 1, AlₓGa₁₋ₓAs_{y}N_{z}P_{1-y-z} where x is greater than 0 and/or less than 1 and y is greater than 0 and/or less than 1, and z is greater than 0 and/or less than 1-y, InₓGa₁₋ₓAs_{y}N_{z}P_{1-y-z} where x is greater than 0 and/or less than 1 and y is greater than 0 and/or less than 1, and z is greater than 0 and/or less than 1-y, Zn₃P₂, Zn₃S₂, and ZnPₓS₁₋ₓ where x is greater than 0 and/or less than 2 and combinations thereof.

In some other instances, the light absorbing layer is made of or includes a metallic material selected from the group consisting of Ti, Al, TiN, Ir, Pd, Pt, Ni, Ru, Ta, conductive oxides of Ir, Pd, Pt, Ni, Sn, Zn, indium or Al-doped SnO₂, Al or Ga doped ZnO, metal silicides, metal germanides, metal nitrides and combinations thereof.

In some instances, the light absorbing layer is made of or comprises bismuth vanadium oxide (BVO).

Methods of forming a light absorbing layer on a substrate, such as from CdS, GaP, or other suitable materials named above, are known in the art and examples are detailed below. In some instances, a powder of the semiconductor is dispersed in a solvent (such as in an alcohol, such as methanol or ethanol) and can be dropped and rolled, or drop-casted, onto a suitable surface of the base substrate during step (a).

In some instances, the light absorbing layer has a thickness in a range from between about 3 nm to about 10 micrometers, as well as any sub-ranges or individual values contained within.

### C. Protective Coating Layer

The protective coating layer is deposited or formed onto the light absorbing layer in optional step (b).

In one instance, the protective coating layer is formed by the steps of:
(1′) depositing at least a first layer on a substrate by atomic layer deposition and/or by sputtering at a predetermined deposition temperature, wherein the at least first layer comprises at least a first metal oxide alloyed or doped with at least one metal selected from the group consisting of manganese, chromium, vanadium, cobalt, oxides thereof, and combinations thereof;
(2′) depositing at least a second layer by atomic layer deposition and/or by sputtering at a predetermined temperature on the at least first layer; wherein the second layer comprises at least a second metal oxide which is optionally free or substantially free of the least one metal selected from the group consisting of manganese, chromium, vanadium, cobalt, oxides thereof, and combinations thereof;
wherein steps (1′) and (2′) are optionally repeated one or more times prior to annealing; and
(3′) annealing the resulting protective coating layer.

Steps (1′) and (2′) may be optionally repeated to grow the protective coating layer to a desired thickness before the (3′) annealing step.

Although reference is made above to first and second layers, in some instances, these layers may be indistinct and may form an intermixed single layer. The intermixed single layer would include the at least a first metal oxide alloyed or doped with at least one metal selected from the group consisting of manganese, chromium, vanadium, cobalt, oxides thereof, and combinations thereof of the first layer and the at least a second metal oxide which is optionally free or substantially free of the least one metal selected from the group consisting of manganese, chromium, vanadium, cobalt, oxides thereof, and combinations thereof of the first and second layers, respectively. The intermixed single layer may be a layer impermeable to water moisture and dissolved ions (wherein “impermeable” refers to less than 5 wt. %, 4 wt. %, 3 wt. %, 2 wt. %, 1 wt. %, or 0 wt. % transfer of water (moisture) and/or dissolved ions).

In some instances, the at least first and/or the at least second layers of the protective coating layer are annealed. Annealing is usually carried out in air or under an inert atmosphere (such as nitrogen, argon, helium, or a mixture thereof) at a temperature ranging from between about 300 to 700° C., 300 to 600° C., or 300 to 500° C. for a period of time ranging from between about 0.1 to 8 hours, 0.1 to 5 hours, or 0.1 to 3 hours, as well as sub-ranges or individual values disclosed within. In some instances, the annealing temperature is about 300° C., 350° C., 400° C., 450° C., 500° C., 550° C., or 600° C. In some instances, the annealing time is about 0.1, 0.5, 1, 1.5, 2, 2.5, or 3 hours. In some cases, the annealing may be carried out with controlled heating ramp rates and/or controlled cooling ramp rates, or heating and/or cooling may be uncontrolled. Suitable heating or cooling ramp rates include about 1° C./min, 2° C./min, 2° C./min, 3° C./min, 4° C./min, or 5° C./min, or higher.

In some instances, the at least first and/or the at least second layer is formed of a metal oxide selected from a titanium dioxide, a tin oxide, or a tungsten oxide. The metal oxide of the first layer can include titanium dioxide (titanium(IV) oxide), titanium(II) oxide, titanium(III) oxide, tin(II) oxide, tin(IV) oxide, tungsten(III) oxide, tungsten(IV) oxide, tungsten(VI) oxide, tungsten pentoxide, or combinations thereof. In the case of the first layer these metal oxides are alloyed or doped with the at least one metal selected from the group consisting of manganese, chromium, vanadium, cobalt, nickel oxides thereof, and combinations thereof.

In certain instances, the at least second layer is free or substantially free of the least one metal selected from the group consisting of silver, iron, palladium, rhodium, iridium, nickel, titanium, chromium, and/or platinum. “Substantially free,” as used here in refers to an atomic percentage present in the layer of a metal which less than 5%, 4%, 3%, 2%, 1%, 0.9%, 0.8%, 0.7%, 0.6%, 0.5%, 0.4%, 0.3%, 0.2%, 0.1%, or less.

The atomic percentage of the at least one metal doped or alloyed into the at least first metal oxide is in the range of between about 1 and 80%, 1 and 75%, 1 and 70%, 1 and 60%, 1 and 50%, 10 and 50%, 20 and 50%, 30 and 50% of the first layer, either alone or in combination with the second layer, as well as sub-ranges or individual values disclosed within. In some other instances the atomic percentage of the at least one metal doped or alloyed in the at least first metal oxide is at least about 1%, 5%, 10%, 15%, 20%, 25%, 30%, 35%, 40%, 45%, 50%, 55%, 60%, 70%, 75%, or 80% of the first layer, either alone or in combination with the second layer. In yet some other instances, the atomic percentage of the at least one metal doped or alloyed in the at least first metal oxide is up to about 1%, 5%, 10%, 15%, 20%, 25%, 30%, 35%, 40%, 45%, 50%, 55%, 60%, 70%, 75%, or 80% of the at least first layer, either alone or in combination with the second layer. The atomic percentages in a layer may be determined by techniques such as X-ray photoelectron spectroscopy (XPS).

The atomic percentages can be controlled by the parameters selected for the ALD or sputtering process, for example the pulse cycles, amongst other selected parameters discussed below. In some instances, the process of forming a layer may include 1-25, 1-20, 1-15, 1-10, or 1-5 cycles of deposition of precursor(s) to form a metal oxide, such as titanium oxide, followed by 1-25, 1-20, 1-15, 1-10, or 1-5 cycles of deposition of other precursor(s) to introduce the at least one metal, which may itself be an oxide of the metal, which is to be alloyed or doped in the metal oxide. In some instances, following deposition of the at least one metal another sequence of 1-25, 1-20, 1-15, 1-10, or 1-5 cycles of deposition of precursor(s) to form metal oxide, such as titanium oxide, may be repeated. In some instances, the process of forming a layer may include at least 1, 2, 3, 4, 5, 6, 7, 8, 9, 10, 11, 12, 13, 14, 15, 16, 17, 18, 19, 20 or more cycles of deposition of precursor(s) to form a metal oxide, such as titanium oxide, followed by at least 1, 2, 3, 4, 5, 6, 7, 8, 9, 10, 11, 12, 13, 14, 15, 16, 17, 18, 19, 20 or more cycles of deposition of other precursor(s) to introduce the at least one metal, which may itself be an oxide of the metal, which is to be alloyed or doped in the metal oxide. In some instances, following deposition of the at least one metal another sequence of at least 1, 2, 3, 4, 5, 6, 7, 8, 9, 10, 11, 12, 13, 14, 15, 16, 17, 18, 19, 20 or more cycles of deposition of precursor(s) to form metal oxide, such as titanium oxide, may be repeated. In some other instances, the ratio of number of cycles of deposition of precursor(s) to form a metal oxide, such as titanium oxide, to the number of cycles of deposition of other precursor(s) to introduce the at least one metal, which may itself be an oxide of the metal, which is to be alloyed or doped in the metal oxide is 1:1, 2:1, 3:1, 4:1, 5:1, 6:1, 7:1, 8:1, 9:1, 10:1, 11:1, 12:1, 13:1, 14:1, 15:, or 16:1. For example, two TiO₂ deposition cycles in the beginning of a super cycle followed by one MnOₓ cycle, and the super cycles of 2:1 cycle ratio repeat.

The ALD or sputtering process can also be used to control the spatial distribution of the least one metal doped or alloyed into the at least first metal oxide. For example, the spatial distribution across a cross-section or the thickness of the first layer may be uniform, non-uniform, or form a gradient. In one non-limiting example, when a gradient is formed the atomic percentage of the at least one metal doped or alloyed into the at least first metal oxide is highest (most concentrated) at the top surface of the layer/film and decreases in concentration through the film thickness toward the bottom surface, or vice versa.

In some instances, the metal oxide of the first layer is alloyed or doped with a metal selected from the group consisting of manganese, chromium, vanadium, cobalt, nickel, and can be defined according to Formula (1) or Formula (2):

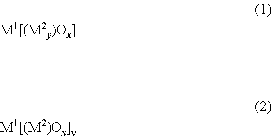

where M¹ is selected from the group consisting of manganese, chromium, vanadium, cobalt, and combinations thereof; M² is selected from the group consisting of titanium, tin, tungsten, and combinations thereof; and y is a composition value which is a >0 real number, such as a value from 0-3, 0-2, 1-3, or 1-2, and x is a composition value which is a >0 real number, such as a value from 0-3, 0-2, 1-2, or 1-3. In some cases, x and y are each integer values of the specified ranges. In some instances, (M²)Oₓ of Formula (2) is a stoichiometric oxide.

The thicknesses of the at least first layer and/or the at least second layer may independently be selected/controlled to be in the range of about 1-100 nm, 5-100 nm, 5-90 nm, 5-80 nm, 5-70 nm, 5-60 nm, 5-70 nm, 5-60 nm, 5-50 nm, 5-40 nm, 5-30 nm, 5-25 nm, 5-20 nm, or 5-10 nm, as well as sub-ranges or individual values disclosed within. In some instances, the combined thickness of the first layer and/or the second layer is selected/controlled to be in the range of about 1-100 nm, 5-100 nm, 5-90 nm, 5-80 nm, 5-70 nm, 5-60 nm, 5-70 nm, 5-60 nm, 5-50 nm, 5-40 nm, 5-30 nm, 5-25 nm, 5-20 nm, or 5-10 nm, as well as sub-ranges or individual values disclosed within. It understood that the combined thickness defines the thickness of the catalyst coating formed during optional step (b).

In some other instances, the protective coating layer has a total thickness in a range from between about 1 nm to about 200 nm, as well as any sub-ranges or individual values disclosed within.

In some instances, the at least first and the at least second layers together may be described as a nanolaminate which is a composite layer or film formed from different materials in a layered stack, where the layers may be alternating layers having a thickness on the order of nanometers. A nanolaminate is not limited to alternating layers of each material, but may include having several layers of one material alternating with a single layer of the other material, to obtain a desired ratio of the two or more materials. A nanolaminate may also include layers of one material formed by an ALD reaction either over or under a single layer of a different material formed by another type of reaction, such as a sputtering reaction. The layers of different materials may remain separate after deposition and/or annealing, or they may modified, such as by annealing.

In atomic layer deposition (ALD), gaseous precursors are introduced/exposed one at a time to the surface of the light absorbing layer within a reaction chamber (or reactor). This introduction of the gaseous precursor(s) takes the form of sequential pulses of each gaseous precursor. In a pulse of a precursor gas, the precursor gas is made to flow into a specific area or region for a suitable period of time. Between the pulses, the reaction chamber is purged with a gas, which in many cases is an inert gas, and/or evacuated. Inert gases may include, for example, nitrogen gas, argon gas, helium gas, neon gas, or a combination thereof. Each cycle results in the formation of a layer or film, as detailed below. ALD reactions may be carried out a predetermined temperature in a reaction chamber which include temperatures in the range of between about 100° C. to 350° C., 100° C. to 300° C., 100° C. to 250° C., or 100° C. to 200° C., as well as sub-ranges or individual values disclosed within. The parameters of each ALD reaction or pulse, such as choice of precursor(s), temperatures, etc. may be independently selected as needed to form the desired composition of a layer.

In the first step of the ALD process the first precursor saturates and is chemisorbed at the surface of the light absorbing layer, during the first pulse phase. Subsequent pulsing or exposure by a purging gas removes excess precursor from the reaction chamber, specifically the precursor that has not been chemisorbed.

A second pulse phase introduces a second precursor where the growth reaction of the desired catalyst layer or film takes place, with a reaction thickness that depends upon the amount of the chemisorbed first precursor. Subsequent to the film growth reaction, any reaction by-products and any precursor excess are purged from the reaction chamber. With a precursor chemistry where the precursors adsorb and react with each other on the substrate, one ALD cycle can typically be performed in less than five, four, three, two, or one second in a suitable flow type reaction chambers. Typically, precursor pulse times range from about 0.5 seconds to about 2 to 3 seconds.

In ALD processes, the saturation of the reaction and purging phases can make the layer or film growth self-limiting. This self-limiting growth results in large area uniformity and conformality. Significantly, ALD provides a means for controlling film thickness by controlling the number of ALD growth cycles.

The precursors used in an ALD process may be gaseous, liquid, or solid. Liquid or solid precursors should be volatile with high vapor pressures or low sublimation temperatures. The vapor pressure should be high enough for effective mass transportation. Further, solid and certain liquid precursors may need to be heated inside the reaction chamber and introduced through heated tubes to the substrate(s). The necessary vapor pressure should be reached at a temperature below the substrate temperature to avoid the condensation of the precursors on the substrate. Due to the self-limiting growth mechanisms of ALD, relatively low vapor pressure solid precursors may be used, though evaporation rates can vary during the process because of changes in surface area.

Precursors suitable for depositing metal oxides, such as those discussed herein, are known. Exemplary metal-containing precursors include commercially available compounds containing titanium, manganese, tin, tungsten, chromium, vanadium, and cobalt. Titanium precursor compounds may include, but are not limited to tetrakis(dimethylamino) (TDMAT), titanium chloride, titanium, tetrakis (diethylamino) titanium (TDEAT), tetrakis(ethylmethylamino) titanium (TEMAT), (trimethyl)pentamethyl cyclopentadienyltitanium, cyclopentadienyl(cycloheptatrienyl) titanium, tris(2,2,6,6-tetramethyl-3,5-heptanedionato)titanium, pentamethyl cyclopentadienyltris(dimethylamino) titanium, titanium t-butoxide, titanium n-butoxide, titanium (di-i-propoxide)bis, titanium ethoxide, and titanium i-propoxide. Tin precursor compounds may include, but are not limited to bis(N,N′-di-i-propylacetamidinato)tin, tin chloride, N,N′-Di-t-butyl-2,3-diamidobutanetin, tetrakis(dimethylamino)tin, tetramethyltin, tin acetylacetonate, tin t-butoxide, and tin(II) hexafluoroacetylacetonate. Tungsten precursor compounds may include, but are not limited to bis(t-butylimido)bis(dimethylamino)tungsten, mesitylene tungsten tricarbonyl, tungsten carbonyl, tungsten chloride, and tungsten oxychloride. Manganese precursor compounds may include, but are not limited to bis(cyclopentadienyl) manganese, bis(N,N′-di-i-propylpentylamidinato)manganese, bis(ethylcyclo pentadienyl)manganese, bis(pentamethylcyclopentadienyl)manganese, his (i-propylcyclopentadienyl)manganese, cyclopentadienylmanganese tricarbonyl, ethylcyclopentadienylmanganese tricarbonyl, tris(2,2,6,6-tetramethyl-3,5-heptanedionato)manganese, and manganese carbonyl. Chromium precursor compounds may include, but are not limited to chromium chloride, bis(cyclopentadienyl)chromium, bis(ethylbenzene)chromium, bis (pentamethylcyclopentadienyl)chromium, bis(i-propylcyclopentadienyl) chromium, chromium acetylacetonate, chromium carbonyl, chromium(III) hexafluoroacetylacetonate, and tris(2,2,6,6-tetramethyl-3,5-heptanedionato)chromium. Vanadium precursor compounds may include, but are not limited to tetrakis(ethylmethylamino)vanadium, tetrakis(diethylamino) vanadium, tetrakis(dimethylamino)vanadium, bis(cyclopentadienyl) vanadium, cyclopentadienylvanadium tetracarbonyl, vanadium acetylacetonate, vanadium trichloride oxide, and vanadium tri-i-propoxy oxide. Vanadium precursor compounds may include, but are not limited to bis(N-t-butyl-N′-ethylpropanimidamidato)cobalt, bis(N,N′-di-i-propylacetamidinato)cobalt, bis(1,4-di-t-butyl-1,3-diazabutadienyl)cobalt, bis(cyclopentadienyl)cobalt, cobalt carbonyl, cobalt carbonyl nitrosyl, cyclopentadienylcobalt dicarbonyl, (3,3-dimethyl-1-butyne)dicobalt hexacarbonyl, and tris(2,2,6,6-tetramethyl-3,5-heptanedionato)cobalt. Nickel: nickel acetylacetonate, cyclopentadienylnickel, bis(N,N′-di-t-butylacetamidinato) nickel(II), Mixtures of the aforementioned metal-containing precursors may be used during an ALD process. Co-reactants or second precursors, such as water or water vapor, methanol, ozone, or ionized oxygen by plasma may be used during ALD in combination with above metal containing precursor compounds, to permit formation of metal oxides thereof.

The ALD precursors demonstrate thermal stability at the substrate temperature. The precursor compounds should chemisorb on, or react with, the surface of the light absorbing layer, though the interaction between the precursor and the surface. The precursors at the surface should react with the second precursor (or co-reactant) to form the desired layer or film. Preferably, any by-products of the reaction should be gaseous in order to allow their removal with ease from the reaction chamber during a purge stage. Finally, the by-products should not react or adsorb on the surface of the light absorbing layer, base substrate, or catalyst coating/film/layer formed.

ALD processes allow for formation of layers or films that can be layered in equal metered cycles or sequences that are all identical in chemical kinetics, deposition per cycle, composition, and thickness. Alternatively, unequal cycles or sequences that are not identical in such parameters may be used. ALD sequences may deposit a complete/full layer or less than a full layer per cycle. Typically, a deposition or growth rate of a layer formed by ALD can be about 0.25 to about 2.00 Å per cycle.

Use of ALD allows for control of continuity at an interface, avoidance of poorly defined nucleating regions, conformality over a variety of substrate topologies due to the layer-by-layer deposition nature of the process, use of low temperature and mildly oxidizing processes, control of growth thickness dependent solely on the number of cycles performed, and ability to engineer multilayer laminate films with resolution of one to two monolayers. ALD processes allow for deposition control on the order of single monolayers and the ability to deposit monolayers of films, such as those described herein.

In some non-limiting instances, a cycle of an ALD deposition includes, for example, pulsing a precursor material, pulsing a purging gas for the precursor, pulsing a second precursor and/or co-reactant, and pulsing the second precursor and/or co-reactant's purging gas, resulting in a controlled deposition thickness that depends upon the amount of the first precursor that adsorbs onto, and saturates, the surface. This cycle may be repeated for any suitable number of times until the desired thickness of the layer or film is achieved. In some instances, it may be alternated with pulsing of a third precursor material, pulsing a purging gas for the third precursor, pulsing a fourth precursor or co-reactant precursor, and pulsing the reactant's purging gas. In some cases, there is no need for a co-reactant if the precursor can interact with the substrate directly.

As a non-limiting example, in the methods described above, in step (1) at least a first layer of titanium oxide (or other metal oxide) can be formed on the light absorbing layer of the base substrate mounted in a reaction chamber using atomic layer deposition (ALD). This can include forming one or more titanium oxide layers using a precursor gas, such as TDMAT and a co-reactant which is water vapor. By way of sequential deposition, the layer may be alloyed or doped with a second metal or metal oxide using ALD, as described. ALD allows control of the number of layers, thicknesses, spatial distribution of the alloyed or doped second metal or metal oxide in the first layer, and the relative atomic percentage present in the layer by facile control of the ALD deposition process (i.e., cycles and parameters thereof). In step (2) of the method, ALD may be used to form at least a second layer of a metal oxide, as described above, which may be free or substantially free of a metal or metal oxide.

In some other instances, the protective coating layer can be formed of, or can include, one or more components selected from a group consisting of TiO₂, SrTiO₃, SnO₂, K₂Ti₂O₅, K₂Ti₄O₉, BaTiO₃, PbTiO₃, ZrO₂, HfO₂, SnO₂, In₂O₃, FeOₓ where x is greater than 0 and/or equal to or less than 1.5, MnOₓ where x is equal to or greater than 1 and/or equal to or less than 2, NiOₓ where x is greater than 0 and/or equal to or less than 1, CoOₓ where x is greater than 0 and/or equal to or less than 1.5, WOₓ where x is equal to or greater than 2 and/or equal to or less than 3, ZnO, Ta₂O₅, NbOₓ where x is equal to or greater than 1 and/or equal to or less than 2.5, Al₂O₃, MgO, SiO₂, and BiOₓ where x is greater than or equal to 1 and/or less than or equal to 2.5.

In some instances, the protective coating layer is formed of a metal oxide selected from the group consisting of a titanium dioxide, a tin oxide, a tungsten oxide, and combinations thereof.

In some instances, the method of forming a protective coating layer during optional step (b) is carried out using known sputtering, thermal evaporation, or electron beam evaporation techniques. In some instances, sputtering is selected from the group consisting of beam sputtering, diode sputtering, and magnetron sputtering.

### D. Catalyst Coating Layer

In the methods described, a catalyst coating layer is deposited or formed over the optional protective coating layer. In some instances, it may be formed or deposited directly on the light absorbing layer.

In one instance, the catalyst coating layer can include formation by the steps of:
(d) depositing at least a first component comprising a first metal oxide or combinations thereof, wherein the first metal oxide is alloyed or doped with at least one metal selected from the group consisting of silver, iron, palladium, rhodium, iridium, nickel, titanium, chromium, platinum, and combinations thereof; and
(e) optionally depositing at least a second component comprising at least a second metal oxide selected from the group consisting of manganese, chromium, vanadium, cobalt, iron, nickel, iridium, ruthenium, and combinations thereof.

Steps (d) and (e) above may be carried out by atomic layer deposition (ALD) and/or by sputtering techniques at a predetermined deposition temperature. Details of ALD and sputtering are known in the art and described in detail, for example, with respect to the protective coating layer, which are incorporated herein in relevant part by reference.

As previously noted, in some other instances, the catalyst coating layer is formed of one or more co-catalysts, such as metal co-catalysts. Typically, two metals are used to form such co-catalysts. The metals of the co-catalysts can be independently selected from transition metals. In some instances, these can be selected from the group consisting of silver, iron, palladium, rhodium, iridium, nickel, titanium, chromium, platinum, and combinations thereof. In some instances, the metals of the catalyst are silver and palladium. In some instances, deposition of co-catalysts involves selecting and depositing a first transition metal which can act a site which facilitates the deposition of a second transition metal. In such instances, the one or more co-catalysts can form a core-shell motif, where a first metal forms a core and a second metal forms a shell over the core. An example of such a motif is shown in FIG. 1A. The size and dimensions of such core-shell metal co-catalysts is not particularly limited. In still other instances, the catalyst coating layer can be formed of a single metal catalyst formed directly over the light absorbing layer, such as when formed of BVO. In such instances, the single metal catalyst is formed of a transition metal, such as palladium. An example of such a motif is shown in FIG. 1B.

When functionalizing panels with co-catalysts or single metal catalysts, as described above, it is important to add these in an amount sufficient to aid in the catalytic reaction, but to not an amount to coat the entire surface and change the chemical properties of the surface or the light absorption performance of the semiconductor layer. A test is to run the photodeposition for varying times and look for a color change. For example, Pd deposition times on BVO panels longer than 5 minutes resulted in a significant color change, which indicated a change in the optical properties of the BVO and can diminish its overall catalytic performance. The 5-minute sample gave only a slight color change, which is why a 5-minute maximum time is preferred in some instances until further characterizations can be done to confirm the catalyst loading level.

In some instances, the catalyst coating layer or components thereof can have a total thickness which can range from between about 0 nm to about 150, about 0 nm to about 100 nm, or about 20 nm to 130 nm, or about 40 nm to 110 nm, or about 60 nm to 90 nm, or about 70 nm to 80 nm, or about 5 nm to 10 nm, or about 10 nm to 20 nm, or about 10 nm to 90 nm, or about 20 nm to 80 nm, or about 30 nm to 70 nm, or about 40 nm to 60 nm, as well as sub-ranges or individual values disclosed within.

In some instances, the optional metal of the first component includes a core-shell structure or a core-shell-shell structure, where the core is a metal, a metal oxide or combinations therein, and each shell, as may be present, is a metal, a metal oxide, or a metal oxide alloy, where the metal is selected from silver, iron, palladium, rhodium, iridium, nickel, titanium, chromium, platinum, and combinations thereof; oxides thereof, or metal oxide alloys thereof. In still other instances, the core of a core-shell structure can be made of silver and the shell of the core-shell structure can be Ag—CrOₓ where x is greater than 0 and less than 1.5, or a titanium oxide, such as TiOₓ, where x is greater than 0 and less than 2. In yet other instances, the core of the core-shell-shell structure is made of silver, the first shell of the core-shell-shell structure is palladium, and the second shell of the core-shell-shell structure is a chromium oxide, such as CrOₓ, where x is greater than 0 and less than 1.5, or a titanium oxide, such as TiOₓ, where x is greater than 0 and less than 2.

In some instances, the catalyst coating layer is formed of co-catalysts which form (nano)islands or (nano)clusters on a surface, such as the top exposed surface, of the protective coating layer. As shown in FIG. 1, the catalyst coating may include islands or clusters having a first transition metal and second transition metal coating the first transition metal. In some instances, the at least first and/or the second components form islands and/or clusters; optionally wherein the islands can be nano-islands and/or the clusters can be nano-clusters. “Islands,” as used herein refer to a disc shape having a thickness of about 1 nm to 50 nm and a diameter ranging from about 2 nm to 500 nm. “Cluster,” as used herein refers to a spherical shape having a diameter of about 1 nm to 500 nm.

In still other instances, the at least first component can further include an oxide surface layer containing a metal selected from the group consisting of silver, palladium, nickel, or combinations thereof.

Methods of depositing or forming the catalyst coating layer are known. For instance, atomic layer deposition (ALD) and sputtering techniques, as described regarding the protective layer, can be used. Photodeposition is also possible. In some other instances, such as when the layer includes co-catalysts these can be formed during step (c) by submerging the catalytic structure produced after step (b) into a solution of a first transition metal salt, such as silver nitrate. Optionally exposing the submerged structure with blue light for a suitable amount of time (such as for at least 15 to 30 seconds) to ensure formation of islands or clusters of the metal on the surface of the catalyst coating. Removing the catalytic structure from the solution of the first transition metal salt once the islands or clusters of the metal are formed and subsequently submerging the catalytic structure into a second solution of a second (different) transition metal salt, such as palladium chloride. Optionally exposing the submerged structure with blue light for a second time and for a suitable amount of time (such as for at least 15 to 30 seconds) to ensure deposition of the second transition metal onto the islands or clusters formed of the first transition metal, thereby completing formation of an exemplary charge separation layer on the catalyst coating.

### IV. Methods of Use

The catalytic structures described herein can form part of a device. In some instances, methane is oxidized into carbon dioxide by use of the catalytic structures described herein, when the structures are used in a device, such as a flow reactor, and a gas stream containing methane is flowed over the catalytic structures in the reactor. In some other instances, as described below, the catalytic structures described herein can be used in a device for gasifying an aqueous biomass to form carbon dioxide, hydrogen, biochar, or mixtures thereof.

In some instances, a device, such as a reactor, can include at least one catalytic structure. In some instances, the device includes a plurality of catalytic structures (i.e., at least 2, 3, 4, 5, 6, 7, 8, 9, 10, 11, 12, 13, 14, 15, or more catalytic structures). Such devices can be used in the methods described below.

In one non-limiting instance, a method of oxidizing methane to form carbon dioxide therefrom, includes the steps of:
(i) contacting one or more catalytic structures, as described herein, with methane; and
(ii) applying an effective amount of a stimulus sufficient to drive oxidation of the methane to form carbon dioxide.

The one or more catalytic structures are typically part of a reactor which can either directly react with the methane and oxidize it into carbon dioxide, or the reactor can operate on a cycle where it first absorbs the methane onto the catalytic surface, and then in a further step washes away the methane with hydrogen peroxide (H₂O₂) to refresh the sorbent (catalytic structures) and produce and oxidized product.

The methane is typically in the form of a gaseous stream including methane gas within and is flowed over the one or more catalytic structures. One consideration for the reactor is the Reynolds number (Equation shown below), which is a ratio of inertial forces to viscous forces in a fluid flow. A low Reynolds number (Re<2000) is associated with laminar flow while a high Reynolds number (Re>3000) is associated with turbulent flow, which has more mixing and is inherently helpful for minimizing transport limited regimes.

$$R e = \frac{ρ uL}{μ}$$

In some instances, the reactor is operated with a gaseous stream with a Reynolds number in a range of between about 15 to 318,000, as well as individual values or sub-ranges contained within the aforementioned range.

In the methods described, molecular oxygen can serve as the oxidation source, but other oxidation sources may be used for the photocatalytic partial methane oxidation. Water, for example, is more easily activated by light energy. In some instances, the method includes the application of solvent vapors during the contacting step, such as, but not limited to, water, ethanol, methanol, and hydrogen peroxide (i.e., 30% hydrogen peroxide) in water, typically by bubbling an inert gas, such as argon, through these solutions.

In some instances of the above method, the stimulus is electromagnetic radiation, such as light, where the light is preferably light having blue wavelengths. In some instances, the light can have a wavelength ranging from about 200 nm to about 1200 nm, as well as sub-ranges and individual values contained within. In some instances, the light can have a combination of multiple wavelengths ranging from about 200 nm to about 1200 nm, as well as sub-ranges and individual values contained within. In some instances, the light includes a wavelength of 450 nm or about 450 nm.

In some instances of the above method, the only or substantially the only product of the oxidation of the methane is carbon dioxide.

For the above method, the methane in step (i) may be dilute methane which is present in combination with one or more gasses (such as air, carbon dioxide, steam). In such instances, the concentration of methane in the gaseous stream may range from about 0.05 vol % to about 30 vol % of the total volume of the gaseous stream. In some instances, the methane is present in mixtures with other gasses, such as inert gasses (i.e., nitrogen and/or argon). The methane oxidized by the methods above, can come from any known methane emission sources (i.e., mine vents, landfills, livestock, cow farms, permafrost, etc.). In some instances, a reactor containing the catalytic structure(s) can be placed and operated near a methane emission source, such as near livestock at a dairy farm.

The methods of oxidizing methane to carbon dioxide can have a conversion efficiency which is at least about 0.1 to about 15%, as determined by the amount of methane input into the reactor which is converted to carbon dioxide and output by the reactor. In some other instances, the conversion efficiency of methane by oxidation into carbon dioxide is sufficient that a flow reactor containing one or more catalytic structures can convert at least about 10 kg to about 100 kg of methane and oxidize it into carbon dioxide from a gas stream containing methane flowed through the reactor.

In certain instances, the reactor can be a flow reactor, which can optionally be a modular reactor, which can be installed up-stream from a conventional and known carbon dioxide capture technology. This would allow further removal (scrubbing) of the carbon dioxide (greenhouse gas) from the output stream of the reactor and prevent it from being released. Accordingly, in some instances, the reactor can be placed in series with a carbon dioxide direct air capture (DAC) device to remove the carbon dioxide before it can escape into the atmosphere. In some other instances, the output from a reactor may be captured and used a source for other commercial purposes, such as an inert gas for welding and fire extinguishers, as a pressurizing gas for air guns and oil recovery, as a supercritical fluid solvent, such as for decaffeination of coffee and supercritical drying. Captured carbon dioxide may also be used as a feedstock for the synthesis of fuels and chemicals.

In yet another non-limiting instance, a method for oxidizing an aqueous biomass to form carbon dioxide, hydrogen, biochar, or mixtures thereof. In one instance, a method of gasifying an aqueous biomass to form carbon dioxide, hydrogen, biochar, or mixtures thereof, includes the steps of
(i′) contacting the catalytic structure, as described herein, with an aqueous biomass; and
(ii′) applying an effective amount of a stimulus sufficient to drive gasification of the aqueous biomass to form carbon dioxide, hydrogen, biochar, or mixtures thereof.

In some instances of the gasifying method above, the method further includes passing the carbon dioxide, hydrogen, biochar, or mixtures thereof through a membrane separation device to separate the carbon dioxide from the hydrogen.

In some instances of the gasifying method, the stimulus is electromagnetic radiation, such as light. The electromagnetic radiation can be light having a wavelength ranging from about 200 nm to about 1200 nm or a combination of wavelengths ranging from about 200 nm to about 1200 nm. In some instances, the light has a blue wavelength of about 450 nm. In some instances, the blue wavelength light is provided by blue light-emitting diode(s) (LED(s)).

In some instances of the gasifying method above, the aqueous biomass includes a cellulosic or lignin component at a concentration from about 5 wt. % to 80 wt. % of the aqueous biomass. In some instances, the cellulosic component includes a paper pulp, a wood waste, a biomass waste, or combinations thereof. A “cellulosic or lignin component,” as used herein refers to a substance or material derived from biomass, such as liquid derived from a biomass, where a biomass is matter from recently living (but now dead) organisms which is used for bioenergy production. Examples of cellulosic and lignin components can include, but are not limited to, wood, wood residues, energy crops, agricultural residues, and organic waste from industry and households.

In some instances of the gasifying method above, the contacting and applying steps are carried out in a reactor or a series of reactors, where preferably each reactor includes one or more catalytic structures disclosed herein. In some instances, the reactor or series of reactors are selected from the group consisting of a plug flow reactor, a continuous stirred reactor, and combinations thereof.

The catalytic structures and/or devices thereof can be provided as a kit. The kits can contain the catalytic structures along with instructions for use thereof, and the end user incorporates the catalytic structure(s) into a device(s), as discussed above.

### Examples

### Example 1. Methane Oxidation Catalytic Reactor

### Full-Scale Reactor Design and Optimization Using Modeling:

A reactor was designed to be able to capture and convert methane from dilute streams while processing large quantities of air every day. The reactor can either directly react with methane and oxidize it into CO₂, or the reactor can operate on a cycle where it first absorbs the methane onto the catalytic surface, and then in a second step washes away the methane with H₂O₂ to refresh the sorbent and produce and oxidized product. Such a modular reactor can be installed up-stream from conventional and known CO₂ capture technologies to further scrub the CO₂ product gases produced from methane from the stream and prevent them from being released into the environment. Even without the further implementation of CO₂ capture technology, a reactor to convert methane to CO₂ is expected to provide a net beneficial effect by slowing atmospheric warming from methane, which is a more powerful greenhouse gas than CO₂.

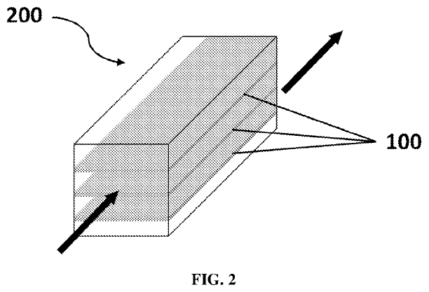

Using the software package COMSOL, a full-scale reactor having multiple catalytic panels (see FIG. 2) was modeled to measure its methane conversion performance. Using the parameters outlined in Table 1, a full-scale reactor that is 1 meter by 1 meter by 10 meters with 10 active catalytic panels can achieve a methane conversion of about 5.4%, which is sufficient for accomplishing a goal to react and oxidize 100 kg CH₄/day. It is noted that due to the large Reynolds number, the modeled full-scale reactor operates in a turbulent flow regime, aiding in gas mixing. As a result, there would be little variation expected in stream's methane concentration with position along the y-axis.

TABLE 1
COMSOL parameters for full-scale methane reactor.

| Parameter | Value |
|---|---|
| Number of catalytic panels | 8 |
| Catalytic Panel Dimensions | 1 meter × 10 meters |
| Reactor Dimensions | 1 m × 1 m × 10 m |
| Methane Diffusivity | 21 cm²/s |
| Air Flowrate | 345 scfm (4.65 m/s) |
| Reynolds Number | 318,000 |
| Reaction Rate | 2.57e−4 mol/(m²s) |
| Percent Methane Conversion | 5.4% |

### Lab-Scale Reactor Design and Optimization Using Modeling:

Issues with low conversion can arise from the fast flowrate through a reactor, resulting in a small residence time, limiting the overall conversion. Nevertheless, the modeled reactor discussed above was optimized to treat the largest volume of air per day that is practically possible in order to optimize the total methane removed from the air. This modeled full-scale reactor would be suitable for commercial applications, but for purposes of testing and optimization of the catalyst panel performance, a reactor of the aforementioned scale would not advisable. Accordingly, COMSOL modeling was also performed on a lab-scale reactor which was built for testing in the lab.

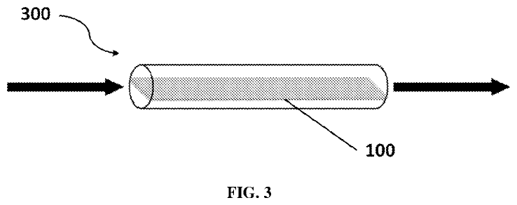

To scale down from the full-scale reactor discussed above, a lab-scale reactor (see FIG. 3) was designed and modeled in COMSOL. To achieve this goal, a simulation to maintain similar conditions to the full-scale model (namely, the catalytic reaction rate) and to determine what magnitude of conversions can be seen in the lab was performed.

Accordingly, an initial COMSOL simulation was performed to test the lab-scale reactor under similar flow dynamics conditions by maintaining the same Reynolds number (318,000) as presented in Table 1. This, however, resulted in a methane conversion of only 0.011%, which would not be easily measurable under lab conditions. As a result, the COMSOL model was simulated for a lower, more practical flow rate that allows for a maximum conversion of 14.3%, which would be readily measurable by common laboratory equipment, as detailed below.

Using the parameters outlined in Table 2, a lab-scale reactor that is 200 m×20 mm diameter with 1 active catalytic panel can achieve a methane conversion of about 14.3%. It is noted that due to the due to the small Reynolds number, the lab-scale reactor is operating in a laminar flow regime, with minimal gas mixing. As a result, there is significant variation in the stream's methane concentration with position along the y-axis.

TABLE 2
COMSOL parameters for lab-scale methane reactor.

| Parameter | Value |
|---|---|
| Number of catalytic panels | 1 |
| Catalytic Panel Dimensions | 100 mm × 20 mm |
| Reactor Dimensions | 200 mm × 20 mm diameter |
| Methane Diffusivity | 21 cm²/s |
| Air Flowrate | 100 sccm |
| Reynolds Number | 18.7 |
| Reaction Rate | 2.57e−4 mol/(m²s) |
| Percent Methane Conversion | 14.3% |

The COMSOL simulations demonstrated that, given the flow and transport constraints of the lab-scale reactor model, an ideal catalyst panel could achieve a maximum conversion of up to 14.3%, which is within the range of many common lab instruments' detection limits.

### Lab-Scale Reactor Construction:

A lab-scale reactor was constructed by wrapping a glass tube with blue LEDs emitting in a range of 440 to 480 nm. These blue LEDs provide a low-cost, easily-scalable, high-energy light source. The inlet of the lab-scale reactor was provided with a stream which consisted of a gas mixture (75% Ar, 20% O₂, 5% CH₄ for all experiments) flowing at 100 sccm for all experiments, and the outlet is monitored via mass spectrometry on an SRS RGA100 mass spectrometer.

To test a catalyst in the reactor, 2 catalytic panels (10 cm long), as described below, were placed back-to-back inside the center of the tube. The mass spectrometer data from before and after the blue light was turned on was compared to calculate the methane conversion and determine any methane oxidation product (i.e., CO₂) generation.

### Catalytic Panel Fabrication:

Every catalytic panel tested in the lab-scale reactor was coated with several layers of materials for specific functions, such as shown in FIG. 1. Each layer's synthetic process and catalytic purpose is described in more detail in its corresponding section. Briefly, every catalytic panel was based on a frosted glass substrate, where a light absorbing (either CdS, GaP, or BVO) layer was deposited. On top of that, an optional catalyst (either TiO₂ or (Ti,Mn)Oₓ) coating was deposited via Atomic Layer Deposition (ALD). Finally, charge separation layer was formed, such as by depositing sequential co-catalysts (Ag and then Pd) or single metal catalyst (Pd) to aid in charge separation.

### Light Absorbing Layer (Either CdS, GaP, or BVO):

Cadmium Sulfide: In a typical synthesis, a frosted glass panel (100 mm×20 mm) was coated with CdS, as described in our previous work (Tianshuo Zhao, et al., PNAS. 118.7 (2021)). First, CdS (100 mg) and CdCl₂ (36.7 mg) are mixed in methanol (20 mL) and sonicated for 10 minutes. The resulting mixture was then filtered via vacuum filtration and the resultant slurry was heated to 80° C. for 20 minutes before being crushed into a powder. That powder was then added to methanol (3 L per mg of powder) and sonicated for 10 minutes. Next, the frosted glass panel was rinsed with HCl (1 M) and then with DI water. Finally, the CdS slurry was deposited onto and rolled out on the frosted glass panel using a clean glass rod before being stored to dry in a nitrogen box.

Gallium Phosphide: Alternatively, to synthesize GaP-based catalytic panels, first a GaP wafer was crushed into a powder via ball milling for 6 hours. The resulting powder was treated by HCl (1 M) and a frosted glass panel (100 mm by 20 mm) was pre-cleaned with acetone and deionized water. The HCl-treated powders were dispersed in ethanol (1 mg/mL) and then drop-cast onto the frosted glass panel.

Bismuth Vanadium Oxide (BVO): the synthesis of the BVO panels was based on previous literature159. Briefly: Bi(NO₃)₃·5H2O (0.2425 g, Sigma Aldrich) and VO(acac)₂ (0.1325 g, Sigma Aldrich) are mixed in 500 L of DMSO and sonicated for 90 minutes, or longer if not all of the powder has been dissolved. The solution is then filtered through a 0.45 μm filter to obtain a 1 M precursor solution. Next, frosted glass panels (cut to be 19 mm×23 mm) are cleaned with ethanol and preheated to 60° C. The panel is placed in a spin coater and 100 L of the precursor solution is added and spread across the panel surface. The spincoater is programmed to spin at 1000 rpm for 20 seconds followed by 3000 rpm for 40 seconds. The panel is then placed in an oven and calcined at 500° C. (heating at 5° C./min) for 2 hours. Finally, the samples are soaked in a 1M KOH solution before further treatment. Each panel was measured to contain approximately 1 mg of BVO after synthesis.

### Optional Protective Coating Layer:

To protect the light absorbing layer's semiconductors (when using CdS or GaP semiconductors), a protective coating layer was applied thereon. This coating minimizes semiconductor degradation while helping prevent semiconductor dissolution during co-catalyst functionalization, where the catalytic panels are submerged in an aqueous solution. The protective coating layer is designed to be conductive to the hot energy carriers (electrons and holes) that are generated when the semiconductor is excited by blue light photons. Two types of coatings were prepared and compared, as follows:

### TiO₂ Coating:

Simple 2 nm or 3 nm coatings of TiO₂ were applied to the light absorbing layer to protect the semiconductors from degradation. These thin coatings were thin enough to easily allow the electrons and holes to transfer to the surface and do not prevent light from reaching the semiconductor. To achieve these coatings, the catalytic panels, following formation of the light absorbing layer, were placed in an atomic layer deposition (ALD) chamber at 250° C. H₂O and tetrakis(dimethylamido)titanium (TDMAT) were pulsed alternatively into the chamber as the oxidizing and titanium precursors, respectively, until the desired coating thickness was achieved.

### (Ti,Mn)Oₓ Coating:

Alternatively, 50 nm coatings of (Ti,Mn)Oₓ were deposited onto the panels with a Ti:Mn ratio of 4:1. This was achieved by inserting an MnO₂ cycle into the ALD process after 4 TiO₂ cycles. After, the panels were annealed at 400° C. to alloy the layers and create a uniform blend of (Ti,Mn)4:1OX.

The addition of the Mn into the TiO₂ lattice aids in hole mobility, allowing the hot carriers to easily reach the surface. The 4:1 (Ti,Mn)Oₓ has also been shown in our previous work (Jiahui Li, et al., Journal of Materials Chemistry A. 9, 18498-18505 (2021); Xin Shen, et al., Advanced Energy Materials, 2022, 2201314) to be active in the water oxidation to hydrogen peroxide reaction, allowing for the direct use of H₂O to generate H₂O₂ in-situ. H₂O₂ has been shown to be an active oxidizing agent, even for methane to methanol reactions (Junying Tang, et al., Joule, 5 (6), 1432-1461 (2021)), which may allow for easier oxidation of methane in the tested reactor. This allows for the catalyst coating to also act as the active site for the methane oxidation half reaction.

### Catalyst Coating Layer:

To aid in the molecular oxygen reduction half-reaction, a charge separation layer was formed made of nanoclusters of co-catalysts or catalysts which were photodeposited onto the catalytic panels following formation of the protective coating layer.

For the Cds and GaP panels, first, Ag nano-islands were deposited by submerging the catalytic panels in a solution of 0.001 mg Ag (from AgNO₃) per 1 mL (of a 4:1 mixture of H₂O and CH₃OH). The catalytic panels were then exposed to blue LEDs for 30 seconds. To deposit the Pd on top of the Ag nanoclusters, the catalytic panels were then placed in a solution of 0.002 mg Pd (from PdCl₂) per 1 mL (of a 4:1 mixture of H₂O and CH₃OH) and illuminated under blue LEDs for 30 seconds. The Pd is active for the O₂ reduction half-reaction, but is easily oxidized in air to PdOₓ, which is not active for the O₂ reduction half-reaction. The Ag nanoclusters provide preferential sites for the Pd to reductively bind to, while also helping increase charge separation and maintain the surface state of the Pd as Pd⁰.

For the BVO panels, only Pd nano-islands were photodeposited, using a solution of 0.1 mM PdCl₂ and 1 mM Na₂SO₃. The solution was degassed by bubbling N₂ through it for at least 30 minutes to remove any O₂. Next, the panels were illuminated under the blue LEDs for 5 minutes before being rinsed with DI water.

### Panel Characterizations:

The BVO panels were analyzed by SEM, EDX, and XPS. The SEM and EDX of the BVO panels before any functionalization or reaction looked very uniform, with the Bi, V, and O all well distributed. However, unlike the uniform results collected on the BVO panel, the Pd-BVO panel and the Pd-BVO post-reaction panel (FIG. 3.9) did not show neat or clear dispersion of the Bi, V, O, and Pd. Images are not shown. The Pd functionalization process altered the morphology of the BVO on the frosted glass panels. Despite the BVO's improved aqueous stability, as compared to CdS or GaP panels, a protective coating may still be needed, in some instances, to retain the BVO composition and morphology. The Bi is clustered around a central particle, while the V was observed to be somewhat spread away and the O completely leached out of the Bi particle, respectively. Concurrently, it was observed that the Pd deposition may not have worked as well as intended, as there was no noticeable Pd signal detected by the EDX. However, Pd was detected by XPS and confirmed to be in the Pd-BVO and Pd-BVO post-reaction samples, and not in the plain BVO sample, indicating that the photodeposition procedure did supply Pd to the catalyst system.

XPS analysis (not shown) showed consistent peaks for the Bi edge across all three samples (BVO panel, Pd-BVO panel, and Pd-BVO panel post-reaction), but looking at the V edge showed significant changes, indicating that the photodeposition process had altered the chemical composition of the light absorber. The absence of the V peaks in the two samples after photodeposition was consistent with the EDX mappings where the V appeared to be leaching out of and away from the material. The O region of the XPS also showed a shifted peak in the BVO sample compared to the Pd-BVO and the Pd-BVO post-reaction, indicating that the photodeposition had altered the oxidation state or chemical environment of the oxygen atoms in the sample. The Pd region of the scan only has peaks in the two samples expected to have Pd. All of these regions do support that the sample was not significantly altered before and after reaction (comparing the Pd-BVO to the post-reaction Pd-BVO), but did show changes before and after photodeposition (comparing the BVO to the Pd-BVO), which was not what was originally hypothesized to be the case. Nevertheless, despite this change in chemical composition and morphology, the Pd-BVO panels did show evidence of catalytic activity for the reaction of interest.

### Reactor Testing and Catalytic Results:

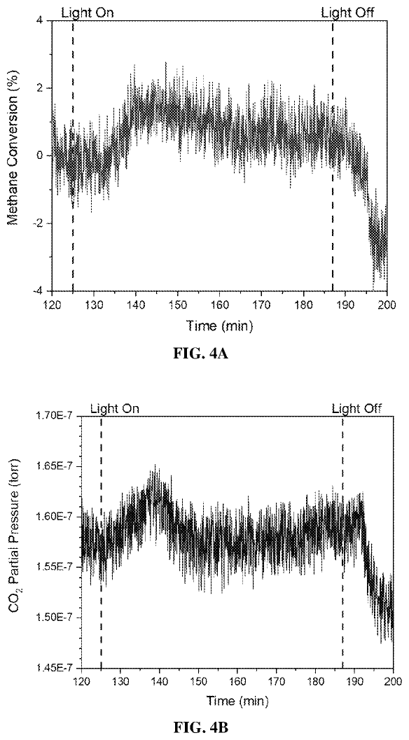

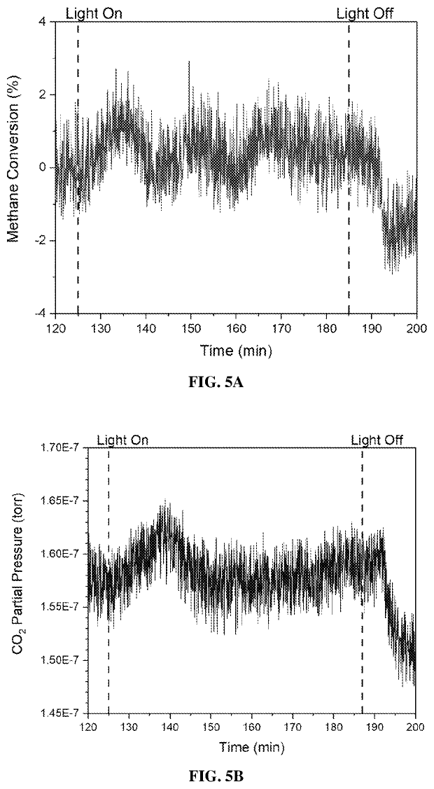

First, the Pd—Ag—(Ti,Mn)Oₓ—CdS and Pd—Ag—(Ti,Mn)Oₓ—GaP panels were both tested while flowing 75% Ar, 20% 02 and 5% CH₄. Both sets of panels had Pd photodeposited onto Ag, which was photodeposited onto 50 nm of (Ti,Mn)₄:Oₓ, which was coated onto either CdS or GaP via ALD. Both of these panels demonstrated, as seen in FIGS. 4A-4B and 5A-5B, respectively, a methane conversion of approximately 2% with a coinciding increase in the CO₂ concentration, indicating a successful methane oxidation to carbon dioxide. Original COMSOL modeling results indicated that a perfect catalyst can achieve a maximum of 14.3%, so this 2% conversion is a positive. From COMSOL simulations, a 2% conversion correlates to a surface reaction rate of 3.61e⁻⁵ mol/(m²s).

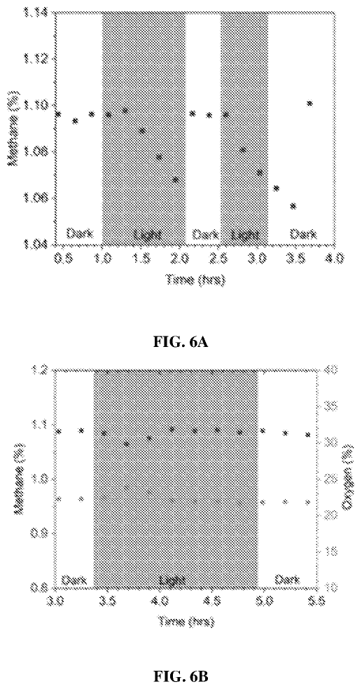

For testing the BVO panel systems, the GC was used to get better resolution for observing changes in the methane concentration. Furthermore, the gas composition was slightly altered to contain 78% Ar, 21% O₂, and 1% CH₄ to both better mimic dilute CH₄ in air and not flood the GC, which was equipped with a column more sensitive to CH₄. Additionally, argon was bubbled through a solvent to allow for an easier oxidation half-reaction. The argon was bubbled through ethanol for the results in FIG. 6A and the argon was not bubbled through any solvent for FIG. 6B, but the panels were dipped into a solution of 30% hydrogen peroxide in water, before being loading into the reactor while still wet. Adding solvents to the vapor phase, such as ethanol, water, and/or hydrogen peroxide allowed for alternative methane oxidation reactions to occur.

With the CdS and GaP panel systems, molecular oxygen served as the oxidation source, but other oxidation sources may be used for photocatalytic partial methane oxidation. Water, for example, is more easily activated by light energy. Therefore, we started adding a variety of solvent vapors such as water, ethanol, methanol, and 30% hydrogen peroxide in water, by bubbling the argon through these solutions. In FIG. 6A, the BVO panels showed evidence of oxidizing methane in the presence of ethanol vapor. After the light was turned on, there is a short delay and then the methane concentration starts dropping. When the light was turned off, the methane concentration immediately returned to its initial value, and this pattern happened again in a second cycle. Additionally, the methane dropped from about 1.10% to 1.07%, for a maximum methane conversion of 2.55%. No conversion was measured in control tests with dry argon, so the ethanol was believed to have some promotional effect for the reaction.

The 2.55% methane conversion correlated to a surface reaction rate of 5.90e-7 mol/(cm2s). A photodiode was calibrated with a power meter and used to measure the light density, which was measured to be 60.2 mW/cm² inside the reactor tube. From this measurement and the surface reaction rate, the faradaic efficiency of the reaction was calculated to be 4.2%±0.3%. For a commercial application, a faradaic efficiency should preferably be slightly higher, closer to 10%.

In FIG. 6B, the BVO panels showed evidence of oxidizing methane in the presence of hydrogen peroxide and water. These panels were dipped into a solution of 30% hydrogen peroxide in water and then loaded into the reactor while still wet. The argon was not bubbling through any solvent. After the light was turned on, there was a small decrease in methane concentration as well as an increase in the oxygen concentration. The methane concentration dropped from about 1.09% to 1.06%, for a maximum methane conversion of 2.28%. The conflicting increase in oxygen concentration was most likely due to the competing reactions of photocatalytic methane oxidation by hydrogen peroxide and the photocatalytic degradation of hydrogen peroxide into oxygen and water. These changes did not last for long, likely due to the exhaustion of the hydrogen peroxide available to the panels, as none was added after the initial dipping procedure. Both the methane and oxygen signals returned to their initial baseline values by the fourth GC scan with the light on, which would have occurred after 52 minutes with the light on.

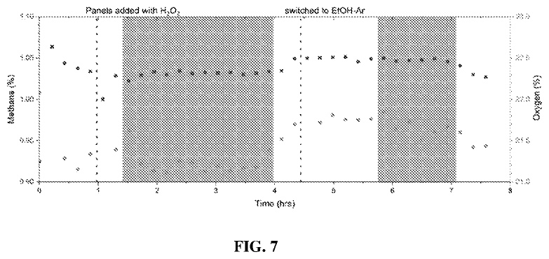

In addition to the Pd-BVO panels, testing was done on Pd—Ag-BVO panels that were synthesized via successive photodeposition of Ag nanoclusters followed by Pd nanoclusters, which selectively deposit on the Ag sites. The Ag helped lock the fermi level of the Pd and prevent an unreactive oxide layer from forming. These panels were tested first by being dipped in hydrogen peroxide and, after enough time, the argon gas was changed to bubble through ethanol to introduce ethanol vapor as another potential oxidizing agent. As seen in the GC results in FIG. 7, there was no significant dependency on the methane or oxygen levels with the blue LED lights being turned on, indicating these panels were unreactive. For both the Pd-BVO and Pd—Ag-BVO panels, no significant product peaks were detected or quantifiable in the GC data.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention. Such equivalents are intended to be encompassed by the following claims.

1. A catalytic structure comprising:
a light absorbing layer;
an optional protective coating layer on the light absorbing layer;
a catalyst coating the protective coating layer, if present, wherein the catalyst coating comprises:
(1) at least a first component comprising a first metal oxide and an optional metal, wherein the first metal oxide is alloyed or doped with at least one metal selected from the group consisting of silver, iron, palladium, rhodium, iridium, nickel, titanium, chromium, platinum, and combinations thereof; and
(2) optionally at least a second component comprising at least a second metal oxide selected from the group consisting of manganese, chromium, vanadium, cobalt, iron, nickel, iridium, ruthenium, and combinations thereof.

2. The catalytic structure of claim 1, further comprising a base substrate.

3-6. (canceled)

7. The catalytic structure of claim 1, wherein the light absorbing layer is made of or comprises CdSe, CdS, BiVO₄, CdSxSe₁₋ₓ where x is greater than 0 and/or less than 1, GaAs, GaP, AlAs, InAs, GaAsₓP₁₋ₓ where x is greater than and/or less than 1, AlₓGa₁₋ₓAs where x is greater than 0 and/or less than 1, AlₓGa₁₋ₓAs_{y}P_{1-y} where x is greater than 0 and/or less than 1 and y is greater than 0 and/or less than 1, InₓGa₁₋ₓAs where x is greater than 0 and/or less than 1, InₓGa₁₋ₓP where x is greater than 0 and/or less than 1, InₓGa₁₋ₓAs_{y}P_{1-y} where x is greater than 0 and/or less than 1 and y is greater than 0 and/or less than 1, AlₓIn₁₋ₓAs_{y}P_{1-y} where x is greater than 0 and/or less than 1 and y is greater than 0 and/or less than 1, AlₓGa₁₋ₓAs_{y}N_{z}P_{1-y-z} where x is greater than 0 and/or less than 1 and y is greater than 0 and/or less than 1, and z is greater than 0 and/or less than 1-y, InₓGa₁₋ₓAs_{y}N_{z}P_{1-y-z} where x is greater than 0 and/or less than 1 and y is greater than 0 and/or less than 1, and z is greater than 0 and/or less than 1-y, Zn₃P₂, Zn₃S₂, and ZnPₓS₁₋ₓ where x is greater than 0 and/or less than 2 and combinations thereof.

8. The catalytic structure of claim 1, wherein the light absorbing layer comprises a metallic material selected from the group consisting of Ti, Al, TiN, Ir, Pd, Pt, Ni, Ru, Ta, conductive oxides of Ir, Pd, Pt, Ni, Sn, Zn, indium or Al-doped SnO₂, Al or Ga doped ZnO, metal silicides, metal germanides, metal nitrides and combinations thereof.

9. The catalytic structure of claim 1, wherein the light absorbing layer is made of or comprises CdS, GaP, or bismuth vanadium oxide (BVO).

10. The catalytic structure of claim 1, wherein the first component or second component, or combinations thereof, form islands and/or clusters; optionally wherein the islands are nano-islands and/or the clusters are nanoclusters.

11-12. (canceled)

13. The catalytic structure of claim 1, wherein the protective coating layer is present and comprises one or more components selected from the group consisting of TiO₂, SrTiO₃, SnO₂, K₂Ti₂O₅, K₂Ti₄O₉, BaTiO₃, PbTiO₃, ZrO₂, HfO₂, SnO₂, In₂O₃, FeOₓ where x is greater than 0 and/or equal to or less than 1.5, MnOₓ where x is equal to or greater than 1 and/or equal to or less than 2, NiOₓ where x is greater than 0 and/or equal to or less than 1, CoOₓ where x is greater than 0 and/or equal to or less than 1.5, WOₓ where x is equal to or greater than 2 and/or equal to or less than 3, ZnO, Ta₂O₅, NbOₓ where x is equal to or greater than 1 and/or equal to or less than 2.5, Al₂O₃, MgO, SiO₂, and BiOₓ where x is greater than or equal to 1 and/or less than or equal to 2.5.

14. The catalytic structure of claim 1, wherein the protective coating layer is present and is formed of or comprises:
(1′) at least a first layer comprising at least a first metal oxide alloyed or doped with at least one metal selected from the group consisting of manganese, chromium, vanadium, cobalt, oxides thereof, and combinations thereof, and
(2′) at least a second layer comprising at least a second metal oxide which is optionally free or substantially free of the least one metal selected from the group consisting of manganese, chromium, vanadium, cobalt, nickel, oxides thereof, and combinations thereof.

15. The catalytic structure of claim 14, wherein the first or the second metal oxide is formed of a metal oxide selected from a titanium dioxide, a tin oxide, a tungsten oxide, or a combination thereof.

16. The catalytic structure of claim 14, wherein the at least one metal alloyed or doped in the first metal oxide is a metal oxide of manganese, chromium, vanadium, cobalt, or a combination thereof.

17. The catalytic structure of claim 14, wherein the second layer is free or substantially free of the least one metal selected from the group consisting of manganese, chromium, vanadium, and cobalt.

18. The catalytic structure of claim 17, wherein the second layer is free of the least one metal selected from the group consisting of manganese, chromium, vanadium, and cobalt.

19. The catalytic structure of claim 1, wherein the protective coating layer is formed of or comprises a metal oxide selected from the group consisting of a titanium dioxide, a tin oxide, a tungsten oxide, and combinations thereof.

20-24. (canceled)

25. A method of forming a catalytic structure comprising the steps of:
(a) depositing or forming a light absorbing layer on a base substrate;
(b) optionally depositing or forming a protective coating layer onto the light absorbing layer;
(c) depositing or forming a catalyst coating onto the protective coating layer, if present, wherein the catalyst coating is formed by the steps of:
(d) depositing at least a first component by atomic layer deposition and/or by sputtering at a predetermined deposition temperature, wherein the at least first component comprises a first metal oxide and an optional metal, wherein the first metal oxide is alloyed or doped with at least one metal selected from the group consisting of silver, iron, palladium, rhodium, iridium, nickel, titanium, chromium, platinum, and combinations thereof; and
(e) optionally depositing at least a second component by atomic layer deposition and/or by sputtering at a predetermined temperature on the at least first component; wherein the second component comprises at least a second metal oxide selected from the group consisting of manganese, chromium, vanadium, cobalt, iron, nickel, iridium, ruthenium, and combinations thereof,
wherein steps (d) and (e) are optionally repeated one or more times.

26-29. (canceled)

30. The method of claim 25, wherein the light absorbing layer is made of or comprises cadmium selenide, gallium phosphide, BiVO₄, GaAs, GaP, GaAsxP1-x, AlxGa1-x where x is greater than or equal to 0 and/or less than or equal to 1, As, AlxGa1-xAsyP1-y where x is greater than or equal to 0 and/or less than or equal to 1 and y is greater than or equal to 0 and/or less than or equal to 1, InxGa1-xAs where x is greater than or equal to 0 and/or less than or equal to 1, InxGa1-xP x is greater than or equal to 0 and/or less than or equal to 1, InxGa1-xAsyP1-y where x is greater than or equal to 0 and/or less than or equal to 1 and y is greater than or equal to 0 and/or less than or equal to 1, AlxIn1-xAsyP1-y where x is greater than or equal to 0 and/or less than or equal to 1 and y is greater than or equal to 0 and/or less than or equal to 1, AlxGa1-xAsyNzP1-y-z where x is greater than or equal to 0 and/or less than or equal to 1 and y is greater than or equal to 0 and/or less than or equal to 1, and z is greater than or equal to 0 and/or less than or equal to 1-y, InxGa1-xAsyNzP1-y-z where x is greater than or equal to 0 and/or less than or equal to 1 and y is greater than or equal to 0 and/or less than or equal to 1, and z is greater than or equal to 0 and/or less than or equal to 1-y, Zn3P2, Zn3S2, and ZnPxS1-x where x is greater than or equal to 0 and/or less than or equal to 2, and combinations thereof.

31. The method of claim 25, wherein the light absorbing layer comprises a metallic material selected from the group consisting of Ti, Al, TiN, Ir, Pd, Pt, Ni, Ru, Ta, conductive oxides of Ir, Pd, Pt, Ni, Sn, Zn, indium or Al doped SnO₂, Al or Ga doped ZnO, metal silicides, metal germanides, metal nitrides and combinations thereof.

32. The method of claim 25, wherein the light absorbing layer is made of or comprises CdS, GaP, or bismuth vanadium oxide (BVO).

33. (canceled)

34. The method of claim 25, wherein the protective coating layer is present and comprises one or more components selected from a group consisting of TiO₂, SrTiO₃, SnO₂, K₂Ti₂O₅, K₂Ti₄O₉, BaTiO₃, PbTiO₃, ZrO₂, HfO₂, SnO₂, In₂O₃, FeOₓ where x is greater than 0 and/or equal to or less than 1.5, MnOₓ where x is equal to or greater than 1 and/or equal to or less than 2, NiOₓ where x is greater than 0 and/or equal to or less than 1, CoOₓ where x is greater than 0 and/or equal to or less than 1.5, WOₓ where x is equal to or greater than 2 and/or equal to or less than 3, ZnO, Ta₂O₅, NbOₓ where x is equal to or greater than 1 and/or equal to or less than 2.5, Al₂O₃, MgO, SiO₂, and BiOₓ where x is greater than or equal to 1 and/or less than or equal to 2.

35. The method of claim 25, wherein the protective coating layer is present and is formed of or comprises:
(1′) at least a first layer comprising at least a first metal oxide alloyed or doped with at least one metal selected from the group consisting of manganese, chromium, vanadium, cobalt, oxides thereof, and combinations thereof, and
(2′) at least a second layer comprising at least a second metal oxide which is optionally free or substantially free of the least one metal selected from the group consisting of manganese, chromium, vanadium, cobalt, nickel, oxides thereof, and combinations thereof.

36-39. (canceled)

40. The method of claim 25, wherein the protective coating layer is formed of a metal oxide selected from the group consisting of a titanium dioxide, a tin oxide, a tungsten oxide, and combinations thereof.

41. The method of claim 25, wherein the first component, the second component, if present, or combinations thereof form islands and/or clusters; optionally wherein the islands are nano-islands and/or the clusters are nanoclusters.

42. (canceled)

43. The method of claim 41, wherein the islands or clusters are formed by depositing islands or clusters comprising a first metal followed by deposition of a second metal onto the islands or clusters; optionally wherein the first metal is silver and the second metal is palladium.

44-48. (canceled)

49. A device comprising the catalytic structure of claim 1, optionally wherein the device is a reactor comprising a plurality of the catalytic structures.

50-51. (canceled)

52. A method of oxidizing methane to form carbon dioxide, the method comprising
(i) contacting the catalytic structure of any one of claim 1 with a gaseous stream comprising methane; and
(ii) applying an effective amount of a stimulus sufficient to drive oxidation of the methane to form carbon dioxide.

53. (canceled)

54. The method of claim 52, wherein the stimulus is electromagnetic radiation.

55-58. (canceled)
